(19) United States
(12) Patent Application Publication
(10) Pub. No.: US 2023/0085542 A1
(43) Pub. Date: Mar. 16, 2023

(54) PLANT-GROWING TRAY AND METHOD

(71) Applicant: International Plant Propagation Technology Limited, Skripton, North Yorkshire (GB)

(72) Inventor: John Cooley, Skripton, North Yorkshire (GB)

(21) Appl. No.: 17/801,792

(22) PCT Filed: Feb. 24, 2021
(86) PCT No.: PCT/GB2021/050458

§ 371 Date: Aug. 23, 2022

(30) Foreign Application Priority Data
Feb. 25, 2020 (GB) 2002603.5
May 26, 2020 (GB) 2007835.8

(51) Int. Cl. A01G 9/02

(52) U.S. Cl. CPC A01G 9/028

(57) ABSTRACT

A plant-growing tray comprises a tray top and a plurality of cells extending downwardly from the tray top. Each cell is for containing a substrate for a plant, for the propagation or growth of the plant. Each cell is associated with a catchment area of the tray top, and each catchment area has a sloped surface which, during watering of the plants in the tray, directs water impinging or falling on the catchment area towards the cell.

### BACKGROUND

In commercial plant-propagation systems, plants may be grown, or propagated, with their roots in any of a number of conventional growing media, or substrates, such as soil, peat or coir.

When large numbers of plants are to be propagated, they may be arranged in trays, each tray holding a plurality of plants, such as typically between 6 and 800 plants. Trays are typically rectangular. In some cases, the trays are handled by hand and in some cases by automated machinery. In use, trays are typically arranged on the ground or on benching or tables.

A tray typically comprises an array of cup-shaped cells, each cell for containing a substrate for propagation of a plant. Traditionally, cells are filled with a loose substrate such as compost and plant seeds or cuttings. During growth, the plants in a cell develop a system of roots which holds together the substrate in a “rootball” or “plug”. A well-developed rootball can be removed from a cell as a single unit of substrate and plant roots, but this only works when enough roots have developed to hold the substrate together.

In some cases, it is desirable to be able to remove rootballs from cells before the roots have fully developed. For example, the grading of plants is often done when the plants are very young and the rootball has not fully developed. It is also desirable to be able to remove the contents of cells that have not successfully grown a plant. However, this is not possible with loose-filled substrates. A popular way of overcoming this problem is to use a stabilized medium, which typically comprises compost contained within some form of material which holds the compost together while the roots of the plant develop, or compost mixed with a binder which holds the compost together. A variety of types of stabilized medium are available, including some which use polymer glues to hold the compost together, and others which contain the compost in a mesh or other suitable material, such as Jiffy® plugs.

A particularly popular form of stabilized medium is a cylindrical, or tubular, stabilized medium, such as an Ellepot®, in which a volume of compost is held in a membrane of a permeable material, such as paper. The membrane is designed to retain the compost so there is no need to wait for roots to develop to be able to extract a plant from a cell, if desired. Cylindrical stabilized media such as Ellepots® comprise a continuous extruded tube of soil, which is wrapped in a membrane and cut into individual cylindrical “plugs” of an appropriate length. Cylindrical stabilized media are therefore naturally parallel sided.

In order to propagate strong and healthy plants, it is desirable that the substrate contained in the cells is regularly supplied with water, and that each cell receives an optimal amount of water, but in practice this is difficult to achieve.

Water is commonly supplied from above, for example using an overhead sprinkler system. While this provides a simple way to supply water to trays comprising a large number of cells, or to multiple trays adjacent to each other, a proportion of the water will not fall into the cells of the tray and will instead fall between the cells. This water may be wasted; the inventors' investigations suggest that in typical plant-growing arrangements, 80% of the water may be wasted in this way. In addition, in these systems it is not possible to ensure that each plant always receives the same, optimal, amount of water.

Water wastage in horticulture is a significant and increasing problem. In particular, in some regions of the world, water is scarce and so water availability is the limiting factor with regard to the varieties and quantities of crops that can be grown. It is highly desirable to reduce water wastage.

It might be suggested that water that does not enter the cells during watering could be recycled. Depending on the circumstances this may be possible, but even if water is recycled it is necessary to ensure that enough water is received by the plant substrate to ensure good plant growth, and so the duration or frequency of watering must be increased to account for water wastage. This increases the work associated with propagating plants as well as the amount of time that the foliage of the plants being propagated is wet. Wet foliage disadvantageously encourages disease.

In order to minimize the space occupied by growing plants in, for example, a greenhouse or polytunnel, trays often have closely packed cells with the space between cells being as small as possible. However, once plants reach a certain size they often need more space if they are to continue to grow. This may be achieved by spacing out the plants within the original tray, leaving empty cells between cells containing plants. Alternatively, plants may be transferred to a purpose-designed growing tray with fewer cells and larger spaces between the cells. The larger the separation between the plants, the larger the proportion of water that falls between the cells, or into empty cells, and so the above-described water-management problems of water wastage and water distribution between cells become more apparent.

Trays comprising cells for containing a stabilized medium may suffer from an additional water-management problem. In order to allow propagation of plants in stabilized media, some prior-art trays have cells in which a plurality of vertical ribs extend inwardly from the walls of cells, or a plurality of projections or lugs are spaced around each cell, extending into the cell. These ribs or projections support a cylindrical stabilized medium in a cell in an upright central position. Between the ribs or projections, apertures or gaps are formed through which air can flow within the cell past the side of the stabilized medium. This intentional design feature advantageously promotes “air pruning” in which roots which protrude from the stabilized medium are killed by the lower humidity, releasing numerous secondary roots and stopping root circling inside the cell. Air pruning thus reduces root circling and promotes a healthy root system. The apertures or gaps also enable the insertion or removal of the stabilized medium into or from the cell, particularly in automated processes; the gaps allow access for mechanical fingers of machinery for inserting or removing the stabilized medium. However, the apertures or gaps may be a significant source of water wastage. Any water that falls between the cells, and that is not immediately wasted, is liable to pour through the aperture or gap around the stabilized medium in each cell and be wasted.

### SUMMARY OF THE INVENTION

The invention provides a plant tray, or plant-growing tray, a cell insert, and a method for watering plants as defined in the appended independent claims, to which reference should now be made. Preferred or advantageous features of the invention are set out in dependent sub-claims.

In a first aspect, the invention may thus advantageously provide a plant-growing tray comprising a tray top from which cells extend downwardly. Each cell is for containing, in use, a substrate for a plant. For example, the tray may comprise a regular array of cells. Each cell is advantageously associated with a catchment area of the tray top having a sloped surface configured such that, in use, water impinging or falling on the catchment area is directed, or flows, towards the cell. For example, a catchment area close to or surrounding each cell may be shaped so as to slope into or towards that cell. The plant-growing tray may thus improve water management by reducing water wastage and improving water distribution to and between the cells of the tray.

In use, at least some, preferably all, of the cells may contain a substrate for growing or propagating a plant. Water may be supplied to the tray to encourage the growth of strong and healthy plants in the substrate. Water supplied to the tray may be distributed across the entire tray, particularly when the water is supplied from above such as in an overhead sprinkler system.

A proportion of the water from, for example, an overhead sprinkler may not fall directly into the cells but will fall between the cells. By providing a tray top with catchment areas between the cells, this water may impinge or fall on the catchment areas rather than being lost, for example to the ground or to benching or a table underneath the tray.

The water impinging on a catchment area may advantageously be directed towards, and into, a cell associated with that catchment area. It is possible to have two or more cells associated with each catchment area, but there is preferably only one cell associated with each catchment area. Because the catchment areas are sloped, this flow of water towards an associated cell may be guaranteed. Therefore, water that may otherwise have been wasted may be directed towards, and into, the cells. Reducing water wastage may advantageously reduce the expense and resources required to propagate plants. By reducing wastage, the quantity of water provided through, for example, a sprinkler system, and/or the frequency of watering, may be much reduced by comparison with conventional systems.

As each cell is associated with a catchment area, water impinging on each catchment area may be directed into each associated cell or cells. This may advantageously mean that, in use, the proportion of water that does not fall directly into cells is distributed between each of the cells, rather than either being lost through any gaps between the cells, or over sides of the tray, or flowing into a subset of the cells, or flowing more rapidly into some cells than others. Preferably, the water is distributed equally between the cells. This may reduce the risk of some of the cells being flooded with water while others are not supplied with enough water. By improving water distribution between cells, the tray may advantageously ensure the survival and consistent growth of plants in each of the cells, and allow more accurate watering of each plant.

Furthermore, the plant-growing tray, or plant-propagation tray, may advantageously allow for large spacings between the cells without the increased water wastage or water distribution problems seen with more widely-spaced plants in the prior art. Generally, the larger the spacing between cells, the larger the proportion of water that is not supplied directly into the cells, because the ratio of the total area of the tray top to the total area of the cells is greater. In trays with large spacings, the centre-to-centre distance between adjacent cells may be at least double the diameter of one of the cells and possibly three times the diameter or more. In a preferred embodiment, each of the cells in a tray may have the same diameter.

Using a tray embodying the invention may enable a large cell spacing to be used, to accommodate larger plants, because water falling between cells may impinge on the catchment areas of the tray top and so may not be wasted. Instead, this water may advantageously be distributed to the cells associated with the catchment areas.

In a plant tray embodying the invention, the catchment areas may advantageously comprise more than 50% or 70% or 90% of the area of the tray top, the area of the tray top being the plan area of the tray excluding the openings at the tops of the cells themselves. This may advantageously optimize the proportion of water that is directed to the cells during watering and minimize wastage. (As described below, the tray top may comprise other features such as openings for ventilation, and so the catchment areas may not form 100% of the area of the tray top.) At the same time, the tray top may advantageously comprise little or no flat area, from which water is not positively directed into cells during watering. Any flat areas of the tray top may comprise less than 20% or 10% of the area of the tray top, or preferably there may be no flat areas at all.

In the prior art, one approach used to reduce water wastage and to improve the distribution of water between cells is to supply the water with drippers, each cell having an individual dripper, rather than using an overhead sprinkler system. Drippers are generally only used to water cells having a large diameter, for example between 80 mm and 120 mm. Water drippers reduce water wastage compared to a prior art overhead sprinkler system but are typically very expensive in terms of capital, installation and management. By allowing efficient and effective watering of trays having large cell spacings, trays embodying the invention may advantageously remove the need for a water dripper system, reducing costs and complexity.

In a preferred embodiment, each cell may be surrounded by its associated catchment area. Therefore, in use, water impinging or falling on the catchment area on all sides of the cell may advantageously be directed into the cell.

In principle, each catchment area may be associated with more than one cell, but in a preferred embodiment, each catchment area may be associated with only one cell.

In a preferred embodiment, the area of each catchment area may be equal. (The area of a catchment area may either be measured in terms of its sloping surface area, or it may be measured as the horizontal extent of the catchment area, which is the area in which it catches water from an overhead sprinkler, for example.) In practice some variability of the catchment areas may be possible, while still achieving the object of the invention of distributing water sufficiently evenly between cells to ensure acceptably uniform plant growth. In addition, the areas and shapes of catchment areas may vary at the edges and corners of a tray, due to the geometry of the tray, while still embodying the invention. In practice, catchment areas having essentially equal areas may differ in area by up to 5% or 10%, although equal areas are preferred in order to optimize water distribution between the cells. In use, and assuming a uniform distribution of water is supplied across the tray, such as might be provided by an overhead sprinkler system, each catchment area may advantageously direct an equal amount of water to its associated cell or cells.

Some prior art trays comprise gaps or openings between cells. Therefore, any water not falling directly into the cells may fall into these gaps and onto the ground beneath the tray. This water is wasted.

Some prior art trays comprise a flat tray-top surface between the cells. Water that does not fall directly into the cells may impinge or fall on that surface. At least some of this water may pour into the cells, but there is no guarantee of this and any water that does not pour into one of the cells may be wasted. For example, water may simply flow off the edge of a tray. Furthermore, there is no guarantee into which cell the water will pour. The distribution of the water pouring into the cells from the surface may be affected by a number of factors, for example, the setup of the irrigation system, the tray being supported on a slope, or a prevailing wind direction. Thus, there is water wastage, and non-uniform quantities of water are supplied to the substrate in each of the cells. If a substrate is supplied with too little water the growth of the plant in the cell may be limited. The plant may even die. If a substrate is supplied with too much water, or supplied too quickly with water, it may become flooded. This may damage the plant in the cell.

Plant-growing trays embodying the invention may alleviate the problems of prior art trays. Any water not falling directly into the cells may advantageously impinge on the tray top and be directed towards the cells and so water wastage is advantageously minimized. The shape of the tray top may also ensure that this water is evenly distributed between the cells to ensure healthy and consistent growth of plants in each cell of the tray, even if the tray is supported on a slope or is not exactly level.

In a preferred embodiment, the plant-growing tray may further comprise a perimeter rib extending upwardly from the tray top along at least portion of a perimeter of one or more of the catchment areas. The perimeter rib may for example extend upwardly a distance of between 1 and 10 mm, or between 2 and 5 mm. Preferably, the perimeter rib may extend upwardly a distance of about 3 mm. The rib may typically be between 1 mm and 3 mm wide. Such a perimeter rib may advantageously contain, or retain, water impinging or falling on a particular catchment area so that the water remains within that catchment area. In particular, the perimeter rib may prevent droplets of water impinging on a particular catchment area from flowing, or overflowing, into an adjacent catchment area, even if there is a prevailing wind for example. Such droplets might otherwise be directed to the associated cell of the adjacent catchment area. Thus, the perimeter rib may contribute to ensuring that water is distributed equally between the cells as desired.

A perimeter rib may preferably extend along all of the perimeter of one or more of the catchment areas, or preferably along the perimeter of each catchment area.

The plant-growing tray may further comprise one or more ventilation holes defined through the tray top, to allow some air to circulate through the tray top. This is desirable in the propagation of certain plants. In a preferred embodiment, at least one ventilation hole may be located between adjacent catchment areas, at a high point in the sloping tray top. Providing ventilation holes between adjacent catchment areas may ensure that water being directed by the catchment areas to the cells does not pass the ventilation holes and so may minimize the risk of water flowing into the ventilation holes.

In a preferred embodiment, a ventilation hole located between adjacent catchment areas may be bounded by or encircled by perimeter ribs of those catchment areas. This may prevent droplets impinging on a catchment area from pouring into the ventilation hole and so being wasted.

Alternatively, a ventilation hole, either between catchment areas or within a catchment area, may be surrounded by its own perimeter wall, to prevent water from flowing into the ventilation hole and being wasted.

Each cell may be designed to hold loose soil or other loose substrate, or in a preferred embodiment of the invention it may be designed to hold a stabilized medium. To hold a stabilized medium, a cell may advantageously comprise a plurality of projections or lugs spaced around and extending into the cell for supporting an upper portion of a stabilized medium within the cell. The stabilized medium is preferably held and supported upright and in a central position within the cell. The projections or lugs also act to guide the stabilized medium into the cell and to hold it central as the internal diameter between the projections and the diameter of the stabilized medium are very similar and thus air movement around the stabilized media is uniform which leads to better plants. Also, the stabilized medium held between the projections is in a known central location so is easier to interact with machinery.

An alternative approach to holding a stabilized medium in a cell may be to use a tapered cell without supporting projections, which tapers inwardly towards its base more rapidly than the shape of the stabilized medium. Stabilized media are typically of circular cross-section, in which case the tapered cell may be correspondingly circular. In such cells, a stabilized medium may be supported by its contact with the walls of the cell towards the base of the cell.

Preferably, however, the cell does not match the shape of the stabilized medium but comprises projections or lugs as described above which support an upper portion of the stabilized medium and, in between the projections, comprises recessed, set back, cell portions which are spaced from the stabilized medium. The gaps thus defined between the projections may provide good access for mechanical handling of the substrate in the cell. In such an embodiment, the spacing between the cell and the substrate is not uniform around the circumference of the cell and has for example two different spacings, one at the projections to hold the stabilized medium, or plug, in place and one recessed to permit aeration/drainage plus machine access.

The projections may, in use, contact the stabilized medium, or they may be shaped and sized so that there is a clearance between the projections and the stabilized medium. In practice, the dimensions of a stabilized medium may vary in manufacture, and may vary during use due to watering or due to plant root growth. It is also important that the features in a cell for supporting a stabilized medium do not grip the stabilized medium so tightly as to prevent the easy insertion or removal of the stabilized medium into or from the cell, including by mechanized processes. Therefore, the projections in a cell for supporting a stabilized medium may be referred to as contacting the stabilized medium but in practice a clearance is generally required.

In use, when a stabilized medium is in a cell and supported by projections or lugs spaced circumferentially around the cell, gaps or openings may advantageously be formed between adjacent projections, between the stabilized medium and a wall or edge of the cell. Air may flow through such gaps or openings to air prune roots in the stabilized medium. Holding the stabilized medium in a central position may thus ensure that the stabilized medium experiences uniform watering, air flow, aeration and drainage which may result in better growing conditions and more uniform plant development.

Furthermore, the gaps may allow for mechanization and automation of the insertion and removal of the stabilized medium into and from the cell. For example, the fingers of a machine for grabbing and moving the stabilized medium may fit into the gaps during insertion and removal, for example, when using robots for the grading or spacing of plants. Without the gaps, the fingers may not be able to access the cell, or the stabilized medium may be squashed or deformed by the fingers. Holding the stabilized medium in a central position may allow the machinery accurately to locate and lift plugs out of the tray.

The radial size of the gaps between the stabilized medium and the edge or wall of the cell, may advantageously correspond to the distance that the supporting projections or lugs extend into the cell. The radial size of the gaps may be for example between 3 and 20 mm, or between 5 and 10 or 15 mm. Access for a mechanical finger typically requires a spacing in this range. The radial size of the gaps may be, for example, between about 4% and 50% of the diameter of a stabilized medium to be received in a cell, or of the diameter of a cell. For example, a stabilized medium may have a diameter of 30 mm and the radial size of the gaps may be between 5 mm and 15 mm, or between about 16% and 50% of the diameter of the stabilized medium. Similarly, a larger stabilized medium may have a diameter of 120 mm and the radial size of the gaps may be between 5 mm and 15 mm, or between about 4% and 13% of the diameter of the stabilized medium.

Typically a cell may comprise four projections spaced at equal 90 degree intervals around the circumference of the cell, with four gaps between the projections. However, a cell may comprise any number of projections in any arrangement suitable to support the stabilized medium. The projections may be evenly spaced around the cell, but may be at any convenient spacings. The projections may be of equal circumferential width or of any suitable circumferential width. If the projections are not evenly spaced or not of equal width, then the gaps between them may be of different circumferential widths.

In further embodiments of the invention, water flow from catchment areas of the tray top to the growing medium, and even to different vertical portions of the growing medium, may be enhanced by careful design of the cell structure. The inventor has found that it is usually beneficial to direct water to the growing medium as high up the side of the growing medium as practical. In that case the water tends to be absorbed into the growing medium and to pass downwards, under gravity, to produce a uniform moisture content throughout the vertical extent of the growing medium. By contrast, if water is directed only to the base of the growing medium then the upper part of the growing medium tends to be much drier, which for growing most plants is less advantageous.

An upper surface of each supporting projection or lug may be adjacent to the catchment area surrounding the cell. Preferably, the upper surface may be level with the catchment area, or it may be lower than the catchment area (with the tray positioned for use). The upper surface may then form a continuous surface with, or a step down from, the catchment area of the tray top. This advantageously allows water directed by the catchment area towards the cell to flow from the catchment area on to the upper surface. This water may flow across or along the upper surface of each projection towards the stabilized medium, for absorption by the stabilized medium. This water might, otherwise, flow directly into the gaps between the stabilized medium and the cell. Depending on the design of the cell, as discussed in more detail below, that water may then be lost.

In a preferred embodiment, at least one the of projections may be shaped or configured such that, in use, water directed by the catchment area flows over its upper surface. For example the upper surface may be formed with a longitudinal channel for carrying the water. The water flowing over the upper surface may tend to flow in the channel rather than over the side of the upper surface and into a gap between the stabilized medium and the projection. Thus, the provision of the channel may, in use, increase the amount of water that impinges on the upper portion of the stabilized medium. As discussed above, the projection in use may contact the stabilized medium or there may be a clearance between the projection and the stabilized medium, but this clearance is preferably small enough to allow water to flow from the upper surface into contact with the stabilized medium so that it can be absorbed by the stabilized medium. In practice, if the gap between the upper surface of the projection and the stabilized medium is less than about 1 or 2 mm, substantial water loss can be avoided. This is in line with the clearance typically required between the projections and the stabilized medium to allow the stabilized medium to be manually inserted into and removed from the cell, but is too small for access by the mechanical fingers of a mechanized handling system and may not be compatible with conventional automated processing systems.

The upper surface of each projection may have any shape that allows water to flow from the catchment area to the stabilized medium, and may be substantially horizontal in use, but preferably the upper surface slopes downwardly into the cell, towards the stabilized medium.

Typically, it is preferable for water to be directed to the upper portion of the stabilized medium by upper surfaces of the projections. Water may then be absorbed from the upper portion throughout the rest of the stabilized medium as a result of gravity and capillary action. This advantageously maximizes the proportion of the roots of a plant in the stabilized medium that receive water. The upper portion may for example be the top third of the stabilized medium but this will depend on the design of the cell. In practice the upper portion of the stabilized medium is the portion in the region of the supporting projections.

In a preferred embodiment, the sloped upper surface of each projection may be shaped to form an upper reservoir adjacent to the stabilized medium in use. In other words, the upper surface of each projection may be shaped such that a quantity of water can be contained by the upper surface, preferably with that quantity of water in contact with the stabilized medium. Therefore, in use, water flowing off the catchment area may be collected by the upper surface in the upper reservoir. Any water impinging on the stabilized medium may not immediately be absorbed. The provision of an upper reservoir may retain some water and so allow for any delay between the water impinging on the stabilized medium and being absorbed by the stabilized medium, for example if the watering process supplies water at a faster rate than can be immediately absorbed by the stabilized medium.

To improve the performance of the catchment areas, in a preferred embodiment the tray may comprise one or more upstanding cell-edge ribs extending around one or more of the cells between adjacent supporting projections or lugs, preferably along an edge between a catchment area and an associated cell.

As described above, in use, there may be gaps or spacings between the stabilized medium and the edge of the cell, for example between adjacent projections. In use, some or even the majority of the water directed by a catchment area may initially flow across the catchment area towards regions of the cell between adjacent projections. The upstanding cell-edge ribs may advantageously serve as a barrier to prevent at least some of this water from flowing into the cell in the gaps or regions between the adjacent projections or lugs. The water may instead be directed towards the upper surfaces of the projections, which are located between the cell-edge ribs. There are preferably no cell-edge ribs between the catchment area and the projections.

The cell-edge ribs may extend upwardly a distance of, or have a height of, at least 1 mm, and preferably no more than 10 mm, or more preferably between 2 and 5 mm. Preferably, the upstanding ribs may extend upwardly a distance of about 3 mm.

The cell-edge ribs and the catchment-area-perimeter ribs may be simple upstanding walls or they may be of more complex shapes, to direct water flow as desired.

In a preferred embodiment, within each catchment area the tray top may be shaped, or sloped, such that water is directed to each of the plurality of projections or lugs. This may advantageously increase the proportion of water that is directed to the plurality of projections rather than to portions of the cell in between the projections.

In a preferred embodiment, the tray top within each catchment area may be shaped such that in use an equal amount of water is directed to each of the plurality of projections when water uniformly impinges on the catchment area. This may for example ensure that an equal amount of water impinges upon a stabilized medium in each cell from each of the plurality of projections supporting that stabilized medium. This may promote uniform wetting at the upper portion of the stabilized medium and reduce the risk of flooding the stabilized medium from one or more of the projections.

The catchment area for a cell may take the form of several catchment-area portions, or segments, each for directing water to one of the projections.

In a preferred embodiment, each cell may comprise a stabilized-medium-supporting rib extending downwardly from each of the projections. In use, the stabilized medium supporting rib may contact the stabilized medium, or there may be a suitable clearance to allow insertion and removal of the stabilized medium into and out of the cell. The supporting rib may advantageously support the stabilized medium.

In a preferred embodiment, a pair of supporting ribs may extend downwardly from each projection or lug. An aperture may be defined between one or more of these pairs of supporting ribs. The aperture may advantageously provide ventilation and aeration of the stabilized medium. Depending on the position of the projections, this ventilation can be high up the cell which is beneficial but is advantageously done in such a way, by placing the vent below the projection above it, and spaced from any lower reservoirs (see below) by the supporting ribs, that there is minimal direct water loss through this vent.

In an alternative embodiment, a projection may not be associated with supporting ribs beneath it, or may only have one supporting rib beneath it. This may increase ventilation but risks disadvantageously increasing water wastage, depending on the design of the cell and on how watering is performed.

In a preferred embodiment, each cell may comprise a side wall. The side wall may extend downwardly from the tray top. An upper portion of the side wall may be spaced (radially) from the stabilized medium in use, for example by between 4% and 50% of the diameter of the cell as described above, and so represents a good method of machine access (for mechanical fingers, for example) and enables good aeration and drainage of the upper portion of the cell. A lower portion of the side wall may be shaped to contact (or to support, with a suitable clearance) a lower portion of the stabilized medium in use.

In a preferred embodiment, a lower reservoir for water may be defined within the cell, for example as part of the shape or structure of a cell. For example a lower reservoir may be defined between a side wall of the cell, the stabilized-medium-supporting ribs of adjacent projections, and the outer surface of the stabilized medium when it is placed in the cell. The lower reservoir may advantageously retain water that flows into it, until the water soaks into the stabilized medium. For example, any water that is not directed from the catchment area to the upper surfaces of the projections, any water which flows over the sides of the projections, and any water that falls directly into a lower reservoir during overhead watering, may flow into a lower reservoir.

Any water flowing into a lower reservoir may advantageously contact the stabilized medium. Therefore this water, which may otherwise have been wasted, may usefully be absorbed by the stabilized medium. Furthermore, the water may impinge on a lower portion of the stabilized medium, below the upper portion supported by the projections. In combination with the supply of water from the supporting projections to the stabilized medium, this may advantageously ensure that a root system of a plant in the stabilized medium receives water along its full length or extent.

The depth of the lower reservoir may advantageously be selected to control where in the stabilized medium water is absorbed. In addition, if the insertion or removal of the stabilized medium is to be mechanized, then the lower reservoir may provide access for the mechanical fingers of a machine. The width and depth of the lower reservoir are therefore preferably sufficient to allow access for the mechanical fingers. In general, the fingers need to be able to grip at least about half the length of the stabilized medium in order to enable secure handling.

In a further aspect of the invention, the cells may be formed with lower reservoirs between the projections or lugs, and the catchment areas and the upper surfaces of the projections may be shaped (for example with convex upper surfaces) so that water falling on the catchment areas flows directly, or preferentially, into the lower reservoirs rather than along the projections to the upper portion of the stabilized medium. For example, the cell may have lower reservoirs and no upper reservoirs, and the cell may have no cell-edge ribs. Such embodiments may prioritize the supply of water to a lower portion of the stabilized medium, supplied from the lower reservoirs, rather than the supply of water to an upper portion of the stabilized medium, supplied from the projections or from upper reservoirs. This approach may be suitable for growing plants which prefer watering at the lower portions of the stabilized medium.

In general, the shapes of the catchment areas, the shapes of the upper surfaces of the projections and the presence or absence of cell-edge ribs or walls may be controlled in order to divide the supply of water between upper and lower portions of the stabilized medium.

In all embodiments, the angle of the slope of the catchment area may determine how fast water flows from the catchment area into the cell. The angle may be chosen to ensure that water flows at a speed in which water flow to the stabilized medium is maximized while avoiding flooding of the stabilized medium. Flooding of the stabilized medium may result in water running off the stabilized medium and being wasted. The optimum angle of the slope may depend on the size of the catchment area, which may in turn depend on the separation between cells of the tray. The angle of the slope, or the average angle of the slope across the catchment area (the slope may vary across the catchment area), is preferably 5 degrees or more in order to ensure that water flows as desired into the cells, even if for example a tray is not supported level, or is slightly tilted, or if there is a prevailing wind. The angle of the slope, or the average angle of the slope across the catchment area, is preferably less than 15, 20, or 25 degrees, in order to avoid the rate of water flow being too great. The angle might be as much as 35 or 45 degrees in some cases, but this is likely to lead to rapid water flow.

It should be noted that because there are usually clearances between the stabilized medium and the features of the cell supporting it, such as the projections or lugs and the supporting ribs, there is not a perfect seal between the cell and the stabilized medium. Therefore, water will flow through these clearances. However, the flow through the clearances is preferably much smaller than the rate of flow of water during watering and so, during watering, the water will flow relatively rapidly along the projections and into upper and lower reservoirs, if present. Water will be absorbed into the stabilized medium, but will also leak gradually through the clearances. Water leaking through the clearances may be wasted, but the reservoirs slow the flow of water and allow time for it to be absorbed by the stabilized medium, thus minimizing waste.

In a preferred embodiment, the upper and lower reservoirs may be shaped to control the rate at which water is absorbed by the growing medium during watering. For example, the rate of absorption can be increased by increasing the area of the growing medium exposed to water held in upper or lower reservoirs.

It is usually desirable to increase the rate at which water is absorbed by the growing medium, in order to decrease the proportion of the water which is wasted by leakage from the reservoirs during watering. Therefore it may be advantageous for the upper and/or lower reservoirs to be shaped, preferably at lower ends of the reservoirs, to have a small radial dimension between a surface of the growing medium and the cell side wall defining the reservoir, and larger lateral dimensions parallel to the surface of the growing medium. The ratio of the minimum lateral dimension to the maximum radial dimension (depth) of this portion of the reservoir may be termed its aspect ratio. A volume of water in a reservoir portion having a higher aspect ratio is absorbed into the growing medium more rapidly than the same volume of water from a reservoir having a lower aspect ratio. In a preferred embodiment, the aspect ratio of at least a portion of a reservoir may be more than 3, or 5, or 10. In practice, aspect ratios greater than 20 or 30 may be difficult to implement because of variability in the dimensions of the growing medium.

In the various embodiments, the plant-growing tray may comprise a rectangular array of cells. The plant-growing tray may comprise an array of 8 cells, or 8, 16, 18, 32, 72, 98, 128, 126, 162, 176, 200 or 800 cells.

The plant-growing tray may be formed of a plastics material, preferably formed as a single piece. The tray may be made by any suitable process, such as injection moulding, thermoforming or blow moulding. It should be noted that if a tray is fabricated by a moulding method, the cells and other features of the tray must all be suitably tapered to enable the tray to be released from the mould.

In a further aspect the invention may advantageously provide a cell insert, or sled, for a plant-growing tray. The insert may comprise a tray-top portion and a single cell, for containing a substrate for a plant, extending downwardly from the tray-top portion. The tray-top portion provides a catchment area for the cell, having a sloped surface configured such that, in use, water impinging or falling on the catchment area is directed towards the cell. The cell insert is receivable in a cell of a plant-growing tray.

In a preferred embodiment a plurality of cell inserts, or sleds, may be inserted into the cells of a plant-growing tray, and the tray-top portions of the cell inserts may abut to form a tray top in which each cell is associated with a catchment area of the tray top. External surfaces of the cell inserts are shaped to fit within the cells of the tray, and to be held upright. Cell inserts may be shaped to hold a growing medium, such as a stabilized medium, which is of a different shape or size from the growing medium that can be accommodated by the tray. The cell inserts can be used to increase the flexibility of a growing system. For example a grower might invest in trays to accommodate stabilized media of a particular size, but for growing a certain type of plant they may wish to use a deeper stabilized medium. If they use their existing trays then the media will protrude above the top surface of the trays, in which case it may be poorly supported, it may receive less water during watering and it may dry out quickly. Using a deeper cell insert creates a more uniform environment vertically for the deeper stabilized media, enhancing growing conditions without the grower needing to invest in a set of deeper trays.

Advantageously, when a plurality of cell inserts is placed in a tray, the abutting tray-top portions of the cell inserts may form a tray top and cells having the features of other embodiments described herein.

Cell inserts may be usable with any plant-growing tray in which the cells provide adequate support for the inserts. If the cell spacing in the tray matches the size of the inserts, then the abutting tray-top portions of a plurality of cell inserts may form a tray top and cells having the advantageous features described herein. If the cell spacing in the tray is larger than the size of the inserts, then there will be gaps between the inserts. In that case, the performance of the inserts themselves may not be affected but there may be some disadvantageous water wastage if watering water falls between the inserts.

In the prior art, levels of water wastage vary depending on parameters such as the spacing between cells, the type of cell and growing medium, or substrate, used and the method of watering. However, the inventor has found that water wastage in prior art systems may be as much as 80% or more, meaning that of the water supplied for plant growth, only 20% or less may be available to the plants. This is a very high level of wastage. In embodiments of the invention there may still be some water wastage for the reasons discussed herein, but the inventor has found that this water wastage may only be 20% or less. This is a dramatic improvement over the prior art. It should further be noted that this reduction in water wastage is combined with the advantage that water supplied to a tray embodying the invention is advantageously evenly distributed between the cells of a tray, for optimum plant growth. In preferred embodiments of the invention the water supplied to a tray may also be distributed within each cell over the depth (or length) of the growing medium, to optimize plant growth and minimize water wastage.

### DESCRIPTION OF SPECIFIC EMBODIMENTS

Specific embodiments of the invention will be now be described by way of example, with reference to the accompanying drawings in which:

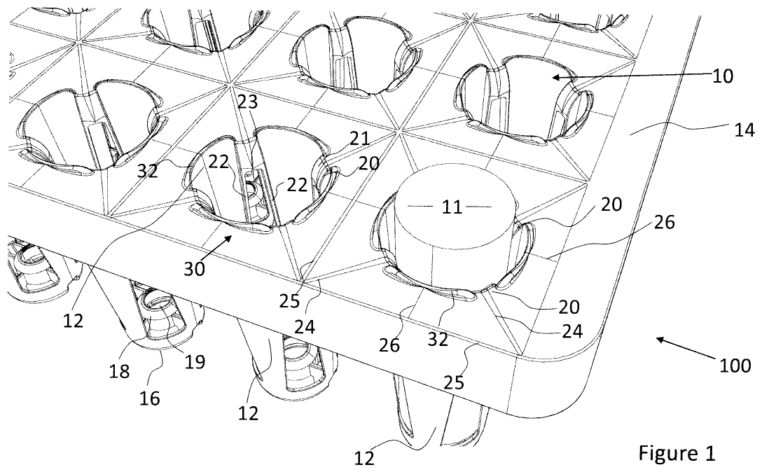

FIG. 1 is a three-quarter view from above of a portion of a plant-propagating tray according to a first embodiment of the invention;

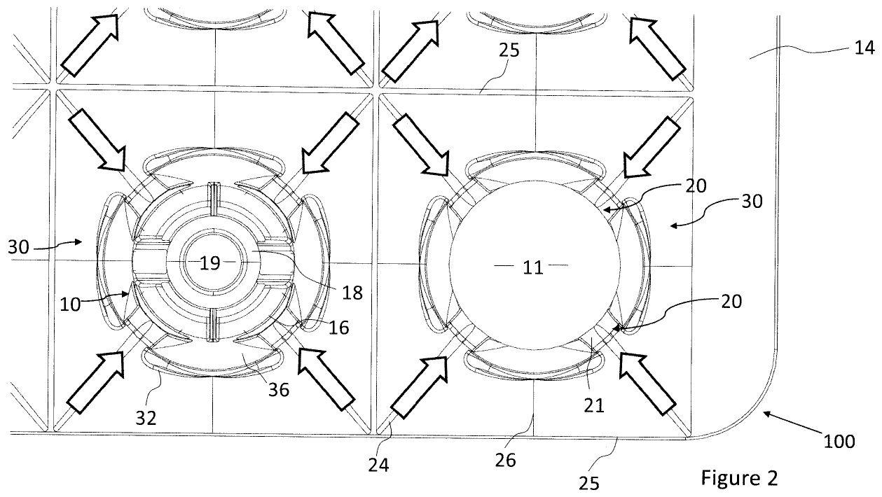

FIG. 2 is a top view of a portion of the plant-propagating tray shown in FIG. 1;

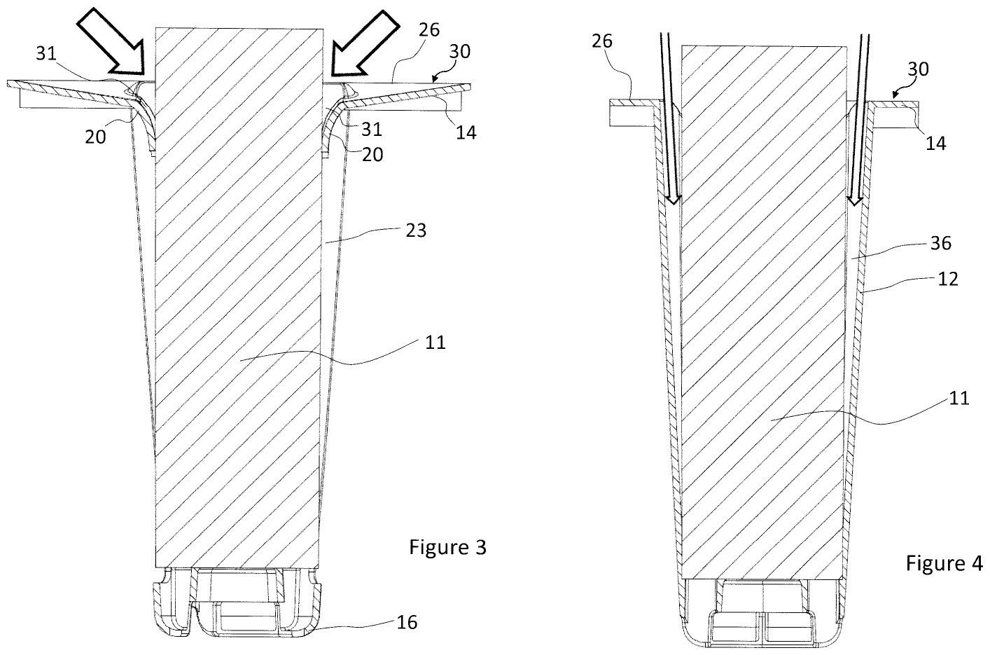

FIG. 3 is a first vertical section of a single cell of the plant-propagating tray shown in FIGS. 1 and 2, sectioned at 45 degrees to an edge of the tray;

FIG. 4 is a second vertical section of the single cell of the plant-propagating tray shown in FIGS. 1 and 2, sectioned parallel to the edge of the tray;

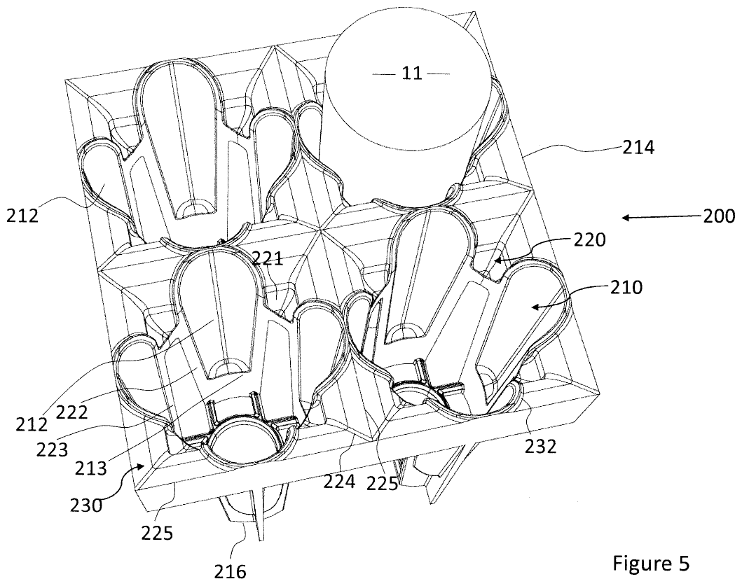

FIG. 5 is a three-quarter view from above of a portion of a plant-propagating tray according to a second embodiment of the invention;

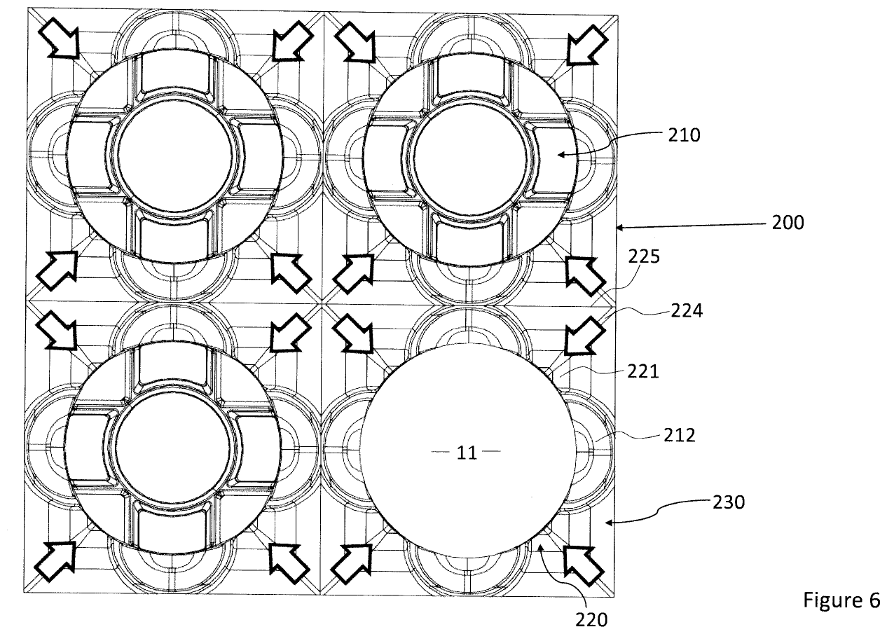

FIG. 6 is a top view of a portion of the plant-propagating tray shown in FIG. 5;

FIG. 7 is a first vertical section of a single cell of the plant-propagating tray shown in FIGS. 5 and 6, sectioned at 45 degrees to an edge of the tray;

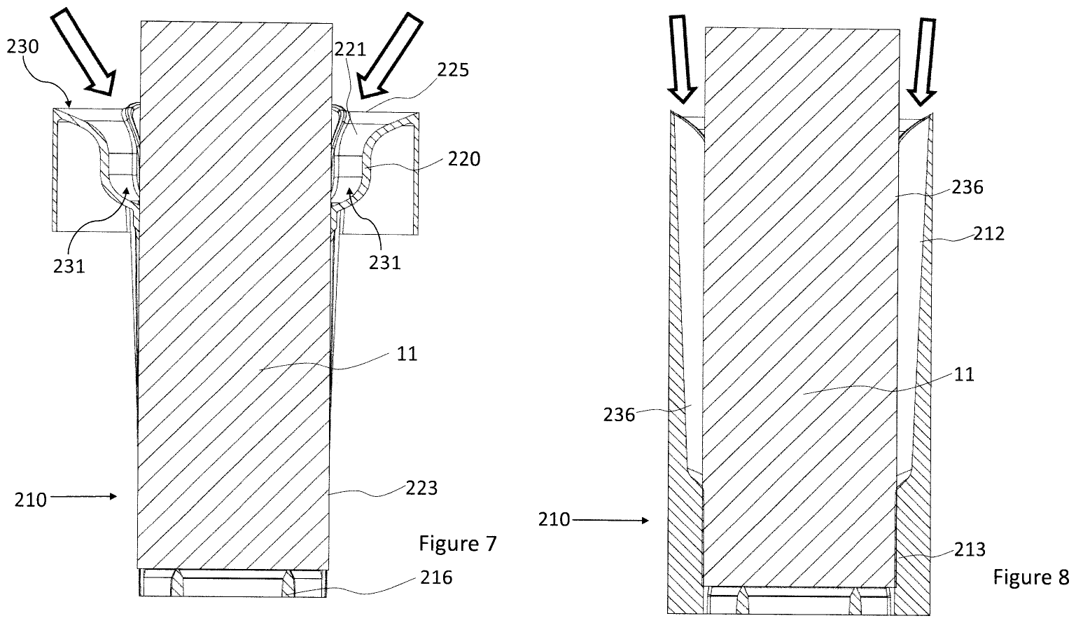

FIG. 8 is a second vertical section of the single cell of the plant-propagating tray shown in FIGS. 5 and 6, sectioned parallel to the edge of the tray;

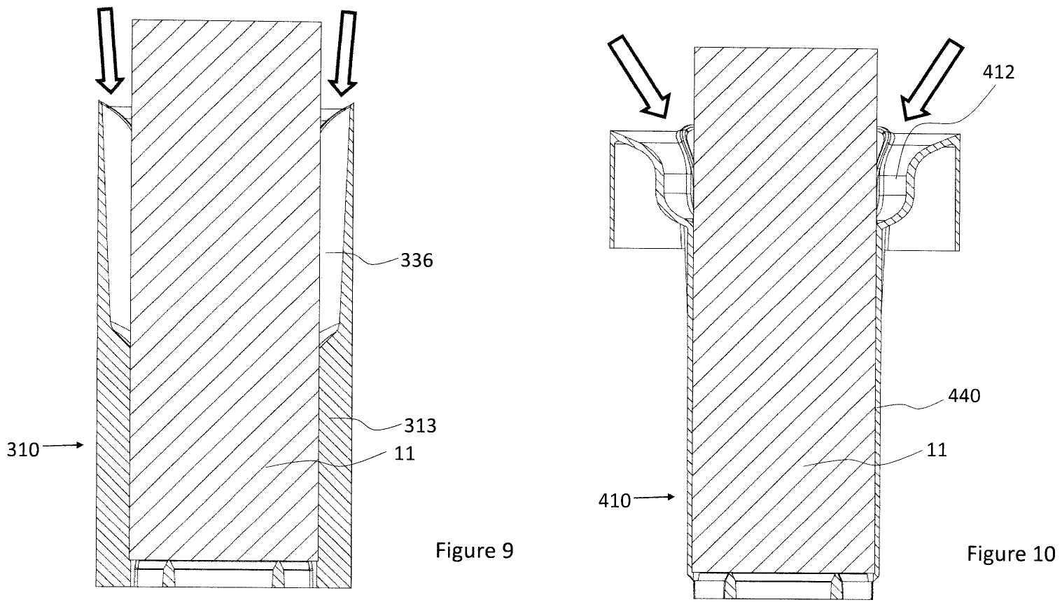

FIG. 9 is a vertical section of a single cell of a plant-propagating tray according to a third embodiment of the invention;

FIG. 10 is a vertical section of a single cell of a plant-propagating tray according to a fourth embodiment of the invention; and

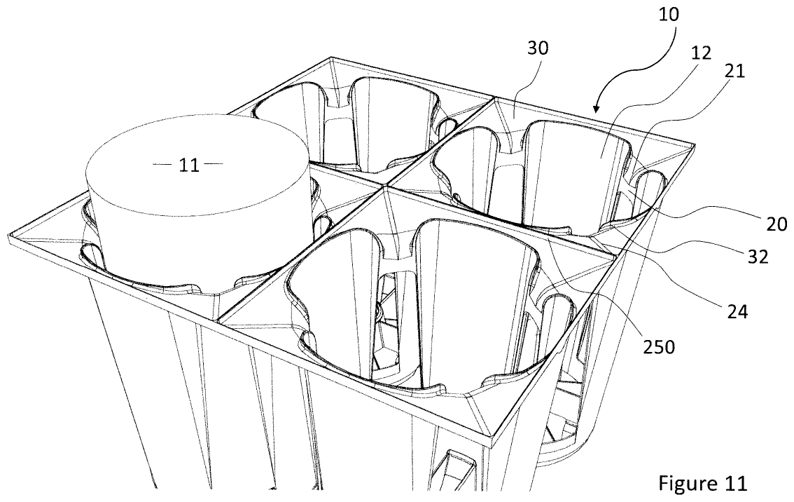

FIG. 11 is a three-quarter view from above of a portion of a plant-propagating tray according to a fifth embodiment of the invention;

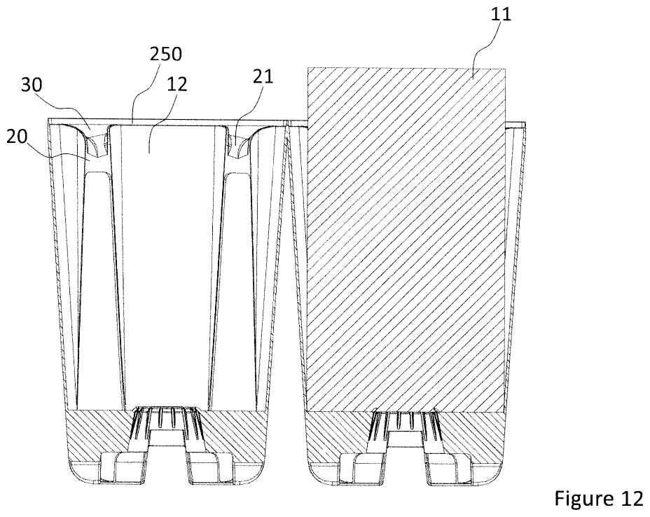

FIG. 12 is a vertical section of two adjacent cells of the plant-propagating tray shown in FIG. 11, sectioned parallel to an edge of the tray;

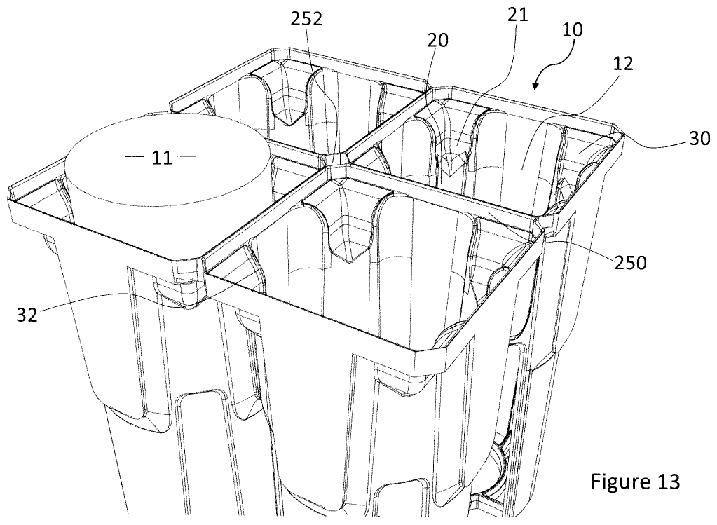

FIG. 13 is a three-quarter view from above of a portion of a plant-propagating tray according to a sixth embodiment of the invention;

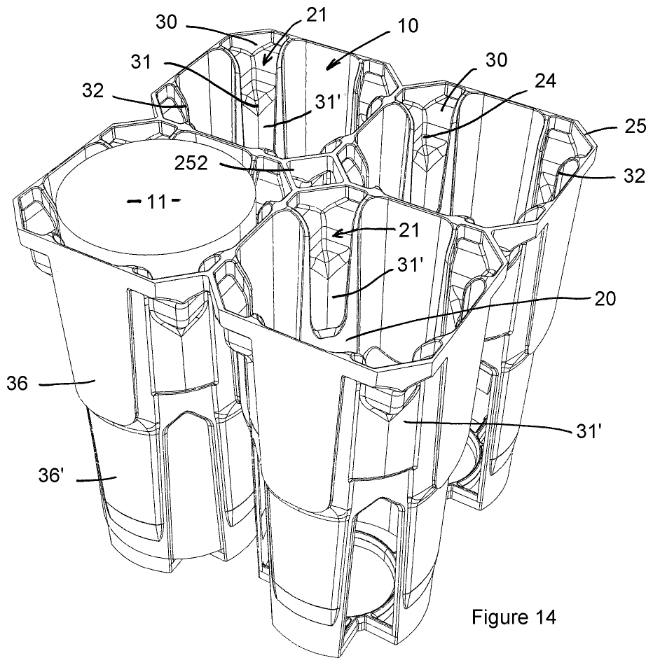

FIG. 14 is a three-quarter view from above of a portion of a plant propagating tray according to a seventh embodiment of the invention;

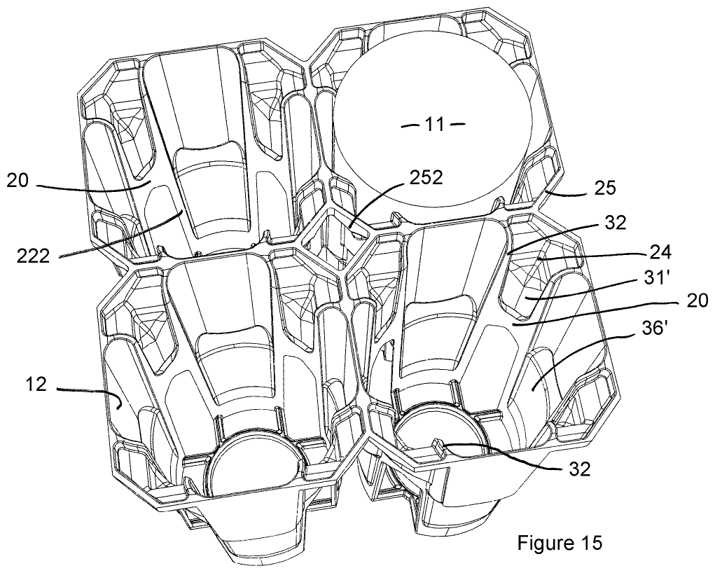

FIG. 15 is a three-quarter view from above of the portion of a plant propagating tray of FIG. 14, viewed from a higher angle;

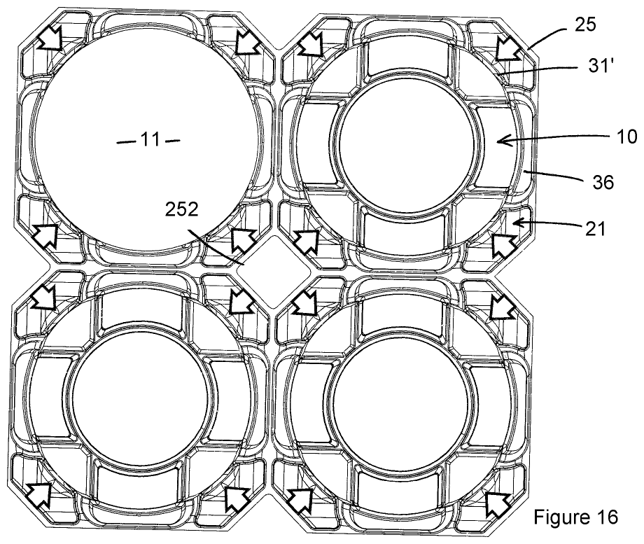

FIG. 16 is a top view of the portion of a plant propagating tray shown in FIGS. 14 and 15;

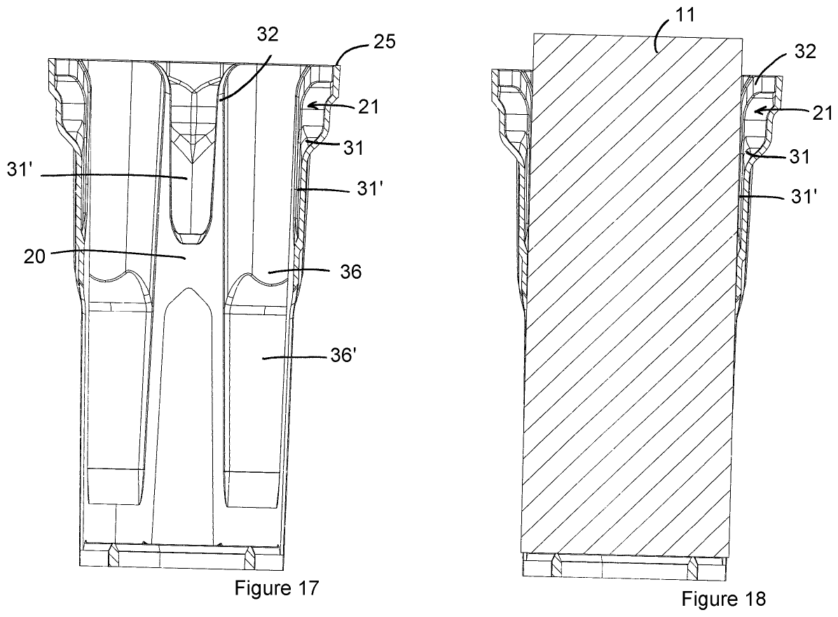

FIGS. 17 and 18 are vertical sections of a single cell of the plant-propagating tray shown in FIGS. 14 to 16, sectioned at 45 degrees to an edge of the tray, respectively without and with a stabilized medium in the cell;

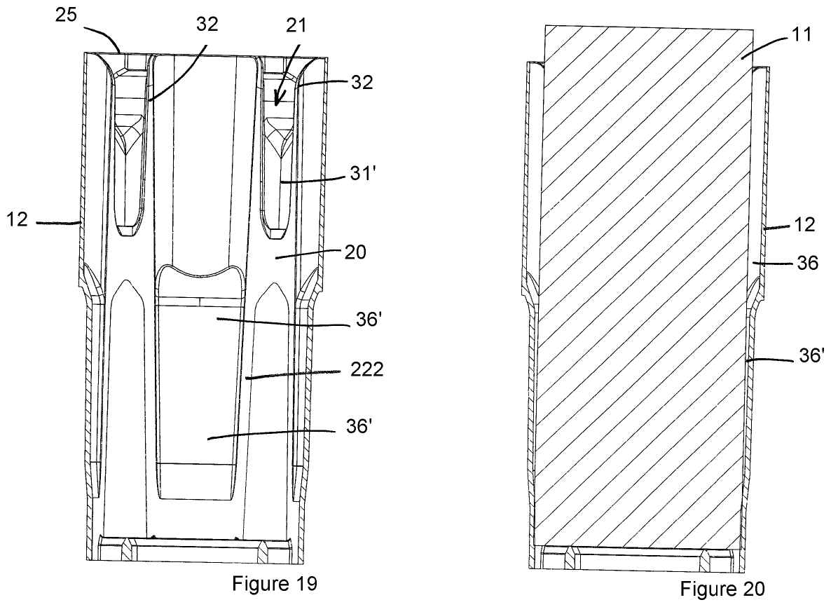

FIGS. 19 and 20 are vertical sections of a single cell of the plant-propagating tray shown in FIGS. 14 to 16, sectioned parallel to an edge of the tray, respectively without and with a stabilized medium in the cell;

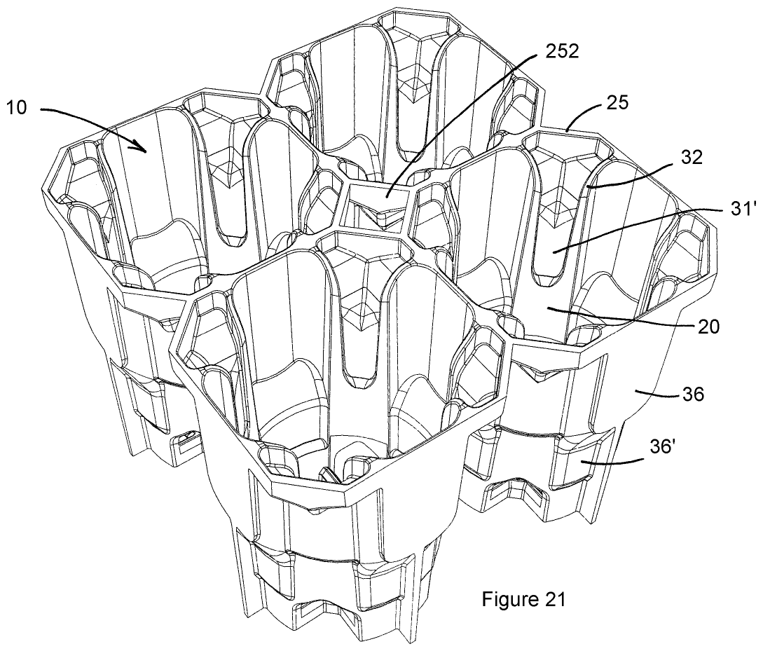

FIG. 21 is a three-quarter view of a portion of a plant-propagating tray according to an eighth embodiment of the invention, similar to the tray of the seventh embodiment but of shallower cell depth;

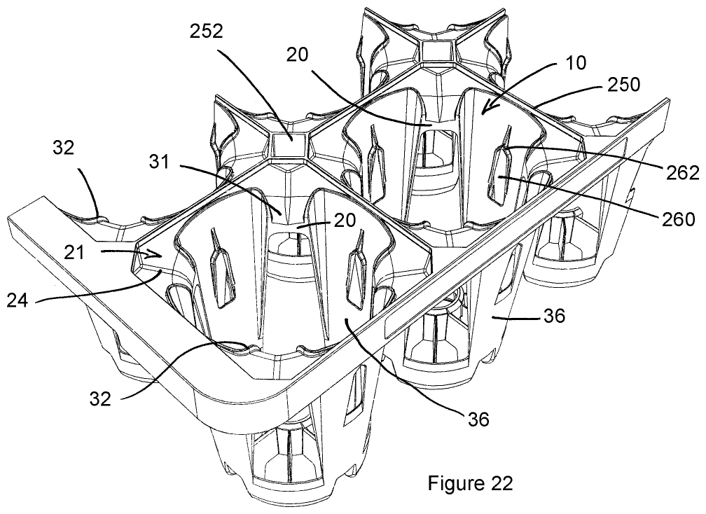

FIG. 22 is a three-quarter view of a portion of a plant-propagating tray according to a ninth embodiment of the invention;

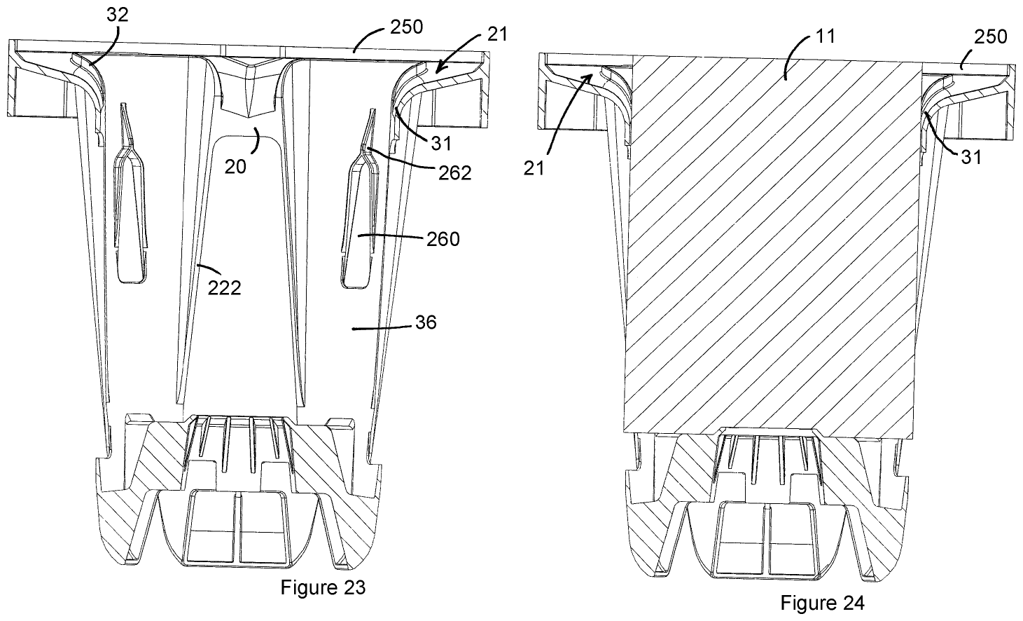

FIGS. 23 and 24 are vertical sections of a single cell of the plant-propagating tray shown in FIG. 22, sectioned at 45 degrees to an edge of the tray, respectively without and with a stabilized medium in the cell;

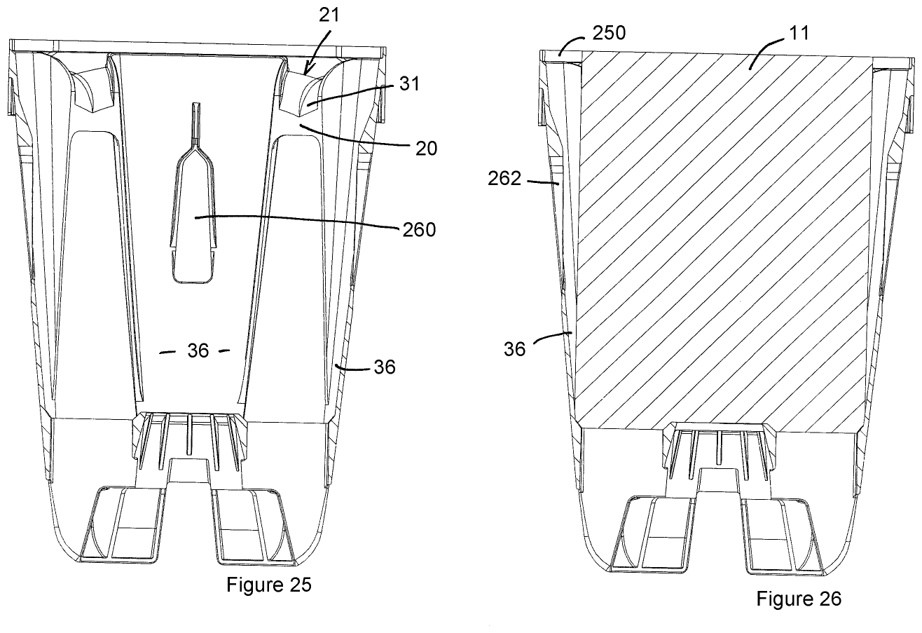

FIGS. 25 and 26 are vertical sections of a single cell of the plant-propagating tray shown in FIG. 22, sectioned parallel to an edge of the tray, respectively without and with a stabilized medium in the cell;

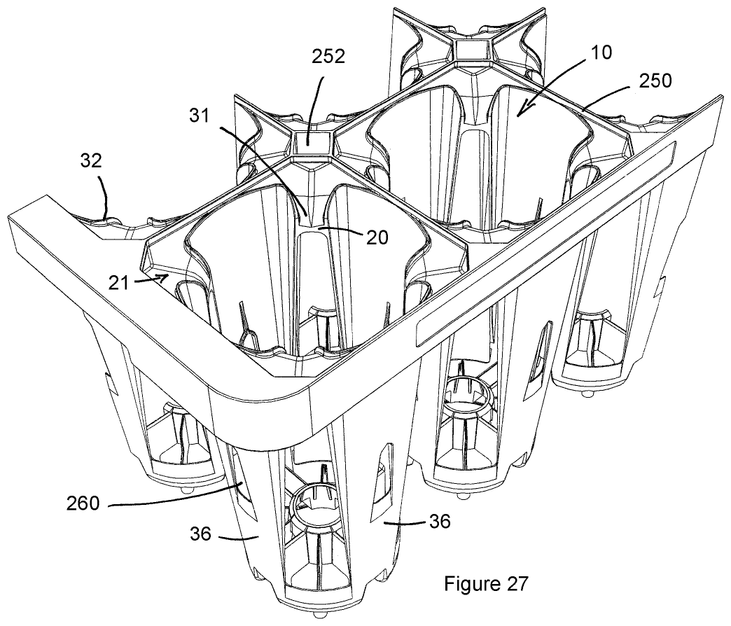

FIG. 27 is a three-quarter view of a portion of a plant-propagating tray according to an tenth embodiment of the invention, similar to the tray of the ninth embodiment but of greater cell depth;

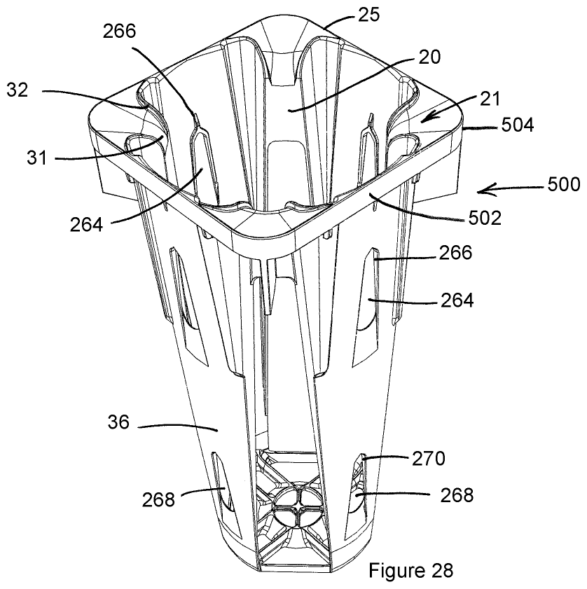

FIG. 28 is a three-quarter view of a cell insert, or sled, according to an eleventh embodiment of the invention, for use with a plant-propagating tray of the ninth or tenth embodiment;

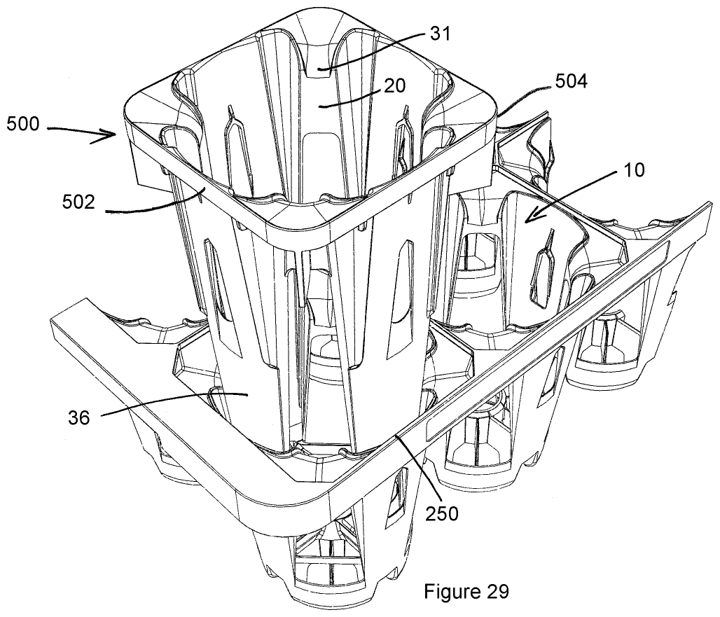

FIG. 29 is a three-quarter view of the cell insert of FIG. 28 in position in a cell of the plant-propagating tray of FIGS. 22 to 26;

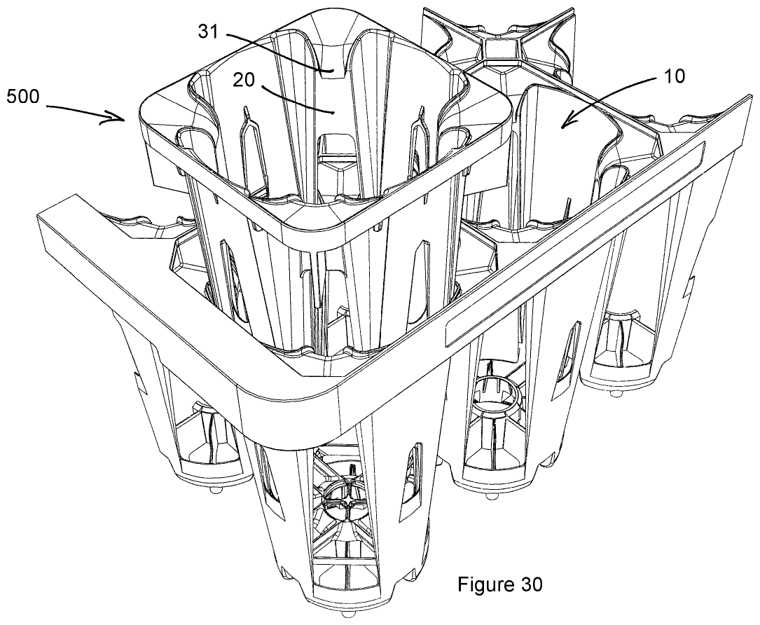

FIG. 30 is a three-quarter view of the cell insert of FIG. 28 in position in a cell of the plant-propagating tray of FIG. 27;

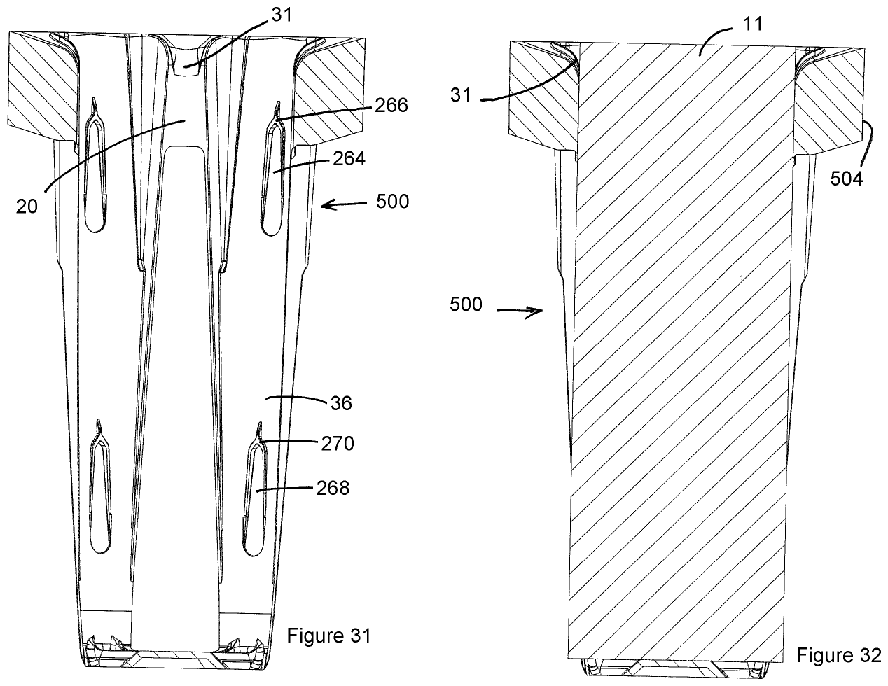

FIGS. 31 and 32 are vertical sections of the cell insert of FIG. 28, sectioned at 45 degrees to an edge of the tray, respectively without and with a stabilized medium in the cell insert;

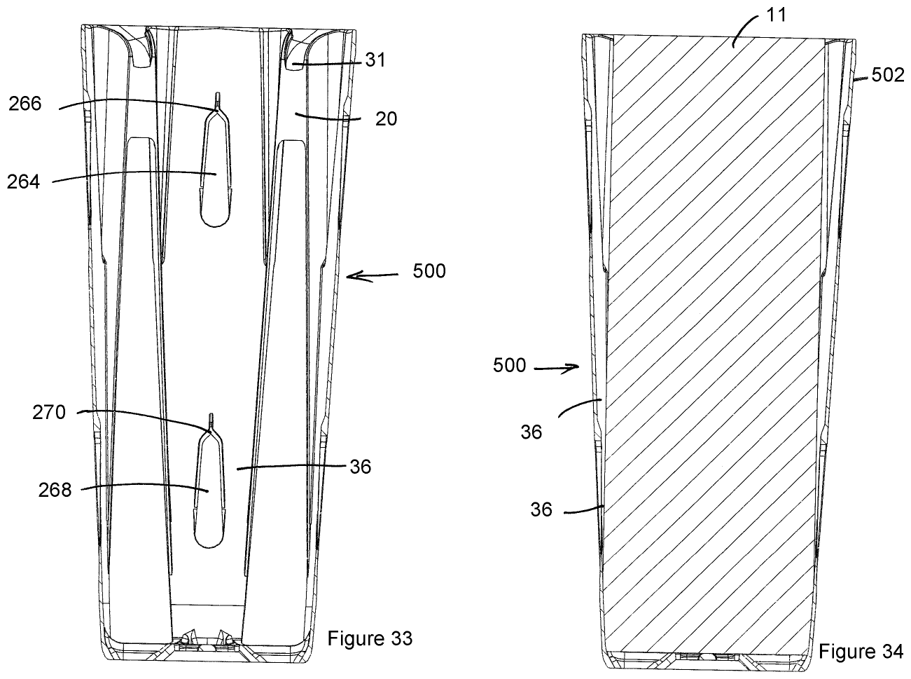

FIGS. 33 and 34 are vertical sections of the cell insert of FIG. 28, sectioned parallel to an edge of the tray, respectively without and with a stabilized medium in the cell insert;

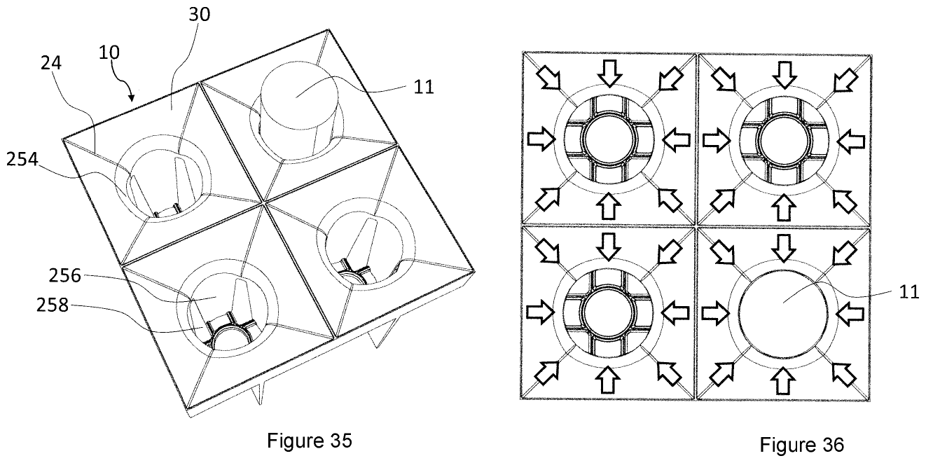

FIG. 35 is a three-quarter view from above of a four-cell portion of a plant-propagating tray according to a twelfth embodiment of the invention;

FIG. 36 is a top view of a portion of the plant-propagating tray shown in FIG. 35;

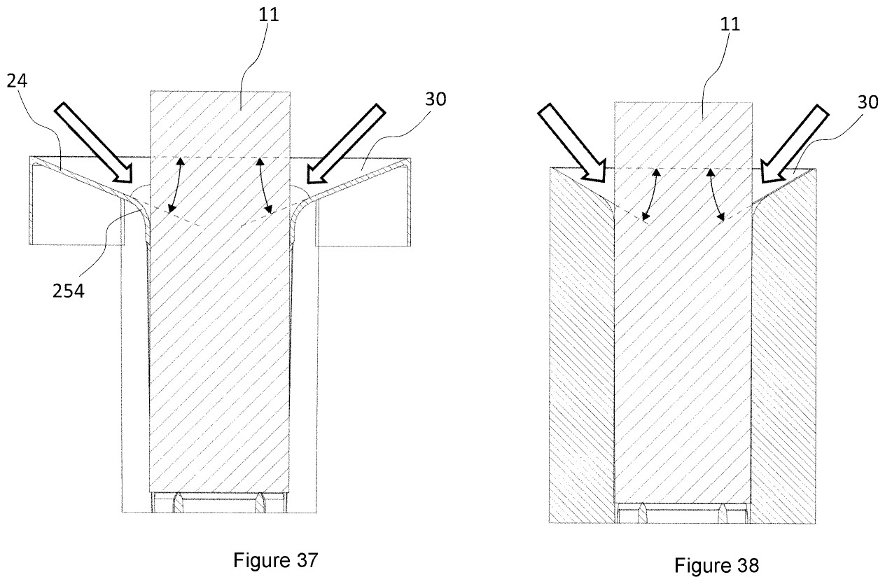

FIG. 37 is a first vertical section of a single cell of the plant-propagating tray shown in FIGS. 35 and 36, sectioned at 45 degrees to an edge of the tray; and

FIG. 38 is a second vertical section of the single cell of the plant-propagating tray shown in FIGS. 35 and 36, sectioned parallel to the edge of the tray;

### DETAILED DESCRIPTION

### Embodiment 1

FIG. 1 shows a portion of a plant tray, or plant-growing tray, 100 according to a first embodiment of the invention. The tray comprises a tray top 14 and a plurality of cells 10, each cell extending downwardly in use from the tray top and being shaped to contain a substrate for a plant. The tray comprises a rectangular array of cells and is formed as a single piece from injection-moulded plastic. FIG. 1 does not show all of the cells of the tray. It shows only a group of cells in a corner of the tray, which are repeated to form the rectangular array of cells in the complete tray, which may be a 6 by 10 array of 60 cells for example.

In the embodiment shown in FIG. 1, the plant-growing substrate is a suitable cylindrical stabilized medium 11, for example an Ellepot®. FIG. 1 illustrates one of the cells 10 containing a stabilized medium 11, as an example. However, in use, preferably each of the cells would contain a stabilized medium.

Each cell 10 comprises four projections or lugs 20 that extend inwardly, into the cell, from an edge of the tray top surrounding the cell. The projections are spaced symmetrically, at 90 degree intervals, around a circumference of the cell and are configured to abut and support an upper portion of a cylindrical stabilized medium within the cell. Beneath each projection, the cell comprises a pair of stabilized-medium-supporting ribs 22 which extend downwardly from the projection to a cell base 16. The cell base 16 comprises a raised central platform 18 within which a circular base hole 19 is defined. The hole allows access for a plunger for automated ejection of plants from the cells.

Each stabilized-medium-supporting rib 22 comprises a supporting edge configured to support a stabilized medium positioned in the cell, along the vertical length of the rib. The supporting edges may contact the stabilized medium but are advantageously arranged so that there is a small clearance between the ribs and the stabilized medium, so that the stabilized medium can be inserted into and removed from the cell. Between each pair of ribs, beneath each projection, an opening or aperture 23 allows ventilation to the stabilized medium, in use. The opening is optional; in alternative embodiments of the invention there may be fewer or no openings. In other words the cell may comprise a continuous surface between some or all of the pairs of ribs.

Adjacent projections, and the ribs extending downwardly from adjacent projections, are connected by cell side walls 12 which extend from the tray top to the cell base.

The support edges of the ribs 22 in a cell lie on a virtual cylindrical shape. A suitable stabilized medium 11 is preferably a corresponding parallel-sided cylindrical stabilized medium. A typical stabilized medium may be of 39 mm diameter and 90 or 120 mm height. In a suitable cell, the spacing between opposed projections may then be 40.3 mm and the spacing between opposed supporting ribs at the base of the cell may be 39.5 mm.

The stabilized medium 11 is thus supported by, or contacted by, the projections and by the support edges of the ribs so that it is supported and held in the middle of the cell. The side walls 12 connecting adjacent projections 20 and ribs 22 are set back slightly such that, when a stabilized medium 11 is received in the cell, gaps or voids are formed between the stabilized medium 11 and the side walls 12.

The gaps or voids advantageously extend downwardly into the cell sufficiently far, and the lateral dimensions of the gaps or voids are sufficient, to allow access by mechanical fingers of automated machinery for inserting and removing stabilized media into and from the cell. Similarly, the gaps or voids extend circumferentially around the stabilized medium in each cell sufficiently to allow access by mechanical fingers.

FIGS. 1 and 2 show how each cell 10 of the plant-growing tray 100 is associated with and surrounded by a catchment area 30 of the tray top 14 having a sloped surface. In use, water is supplied to encourage the growth of strong and healthy plants growing in the stabilized medium. The water is supplied from above using an overhead sprinkler system. A proportion of the water falls on each catchment area 30 and the sloped surface of each catchment area 30 is configured such that, in use, the water flows downhill towards the cell 10 associated with that catchment area 30. As each cell 10 is associated with a catchment area, water supplied to the tray is distributed evenly, or equally, between the cells. This reduces the risk, as with prior-art trays, of some of the cells being flooded with water while others are not supplied with enough water.

Each catchment area 30 surrounds its associated cell 10 and each catchment area 30 is associated with only one cell. Furthermore, the area of each catchment area 30 is the same, to ensure that equal amounts of water are directed toward each cell.

Each catchment area is bounded by perimeter ridges 25 (formed between the slopes of adjacent catchment areas) which separate it from adjacent catchment areas (or which bound the catchment area at the edge of the tray). In an alternative embodiment, perimeter ribs or walls may extend upwards along some or all of the perimeter ridges to further separate water falling on different catchment areas.

The tray top in each catchment area 30 is shaped to form four inclined valleys 24, each sloping radially inwards and downwards towards one of the projections or lugs 20 for supporting the stabilized medium.

Each catchment area is subdivided into four sections, each for directing water into one of the valleys. Each section is bounded by ridges 26 which are symmetrically arranged between adjacent valleys and extend radially between an edge of the cell and the perimeter ridge 25 bounding the catchment area. Therefore, water impinging on one of the four sections of each catchment area flows away from the ridges 25, 26 into the associated valley 24, and then towards the associated projection 20. The arrows of FIG. 2 lie along the valleys, and represent water flowing along the valleys towards the cell 10. The arrangement of four sections within each catchment area aims to ensure that water falling on the tray top is directed evenly, or equally, towards each of the four projections.

Each projection 20 comprises an upper surface 21, which slopes downwardly from a first end adjacent the tray top at the end of a valley to a second end which abuts the stabilized medium in the cell. The upper surface 21 is shaped to form a channel having an inlet at the first end and an outlet at the second end.

The tray 100 additionally comprises upstanding cell-edge ribs or walls 32 extending around each cell 10 on either side of each projection 20. As shown in FIG. 1, these ribs extend from each projection, around the cell edge to the ridge 26 which bounds the section of the catchment area associated with that projection.

In use, some of the water directed by the catchment area 30 may flow towards regions of the cell between adjacent projections. The cell-edge ribs 32 serve as a barrier to prevent at least some of this water from flowing directly into the cell. The water instead flows towards the upper surfaces 21 of the projections 20. As shown in FIG. 1, the cell-edge ribs 32 are curved away from the cell to form a lip extending over the catchment area. This shape encourages or promotes water to be directed to the projections 20.

It should be noted that the perimeter ridges 25 which bound the catchment areas all lie on a flat plane, and that all of the features of the shaped tray top lie (with the tray oriented for use) level with or below that plane. Thus, in the embodiment, the ridges 26 which separate the four sections of each catchment area lie in the same plane as the perimeter ridges, and the cell-edge ribs 32 are shaped to lie below or level with the plane. This may advantageously allow similar trays to be nested with each other efficiently, one on top of the other. This is very advantageous for storage and transport of the trays, and it is preferable if the shaping of the tray top to allow efficient watering of the plants in a tray is not to reduce the ability of the trays to nest with one another.

FIG. 3 is a vertical section of a cell, taken through two diametrically-opposed projections 20. The upper surface 21 of each projection 20 and the catchment area 30 forms a continuous surface. This allows water directed by the catchment area 30 towards the projections 20, to flow along the channel over the upper surface 21 of the projections 20 to the upper portion of stabilized medium 11. Water impinges upon the upper portion of the stabilized medium 11 and is absorbed.

The upper surface 21 of each of the projections 20 may also be shaped to form an upper reservoir 31, defined between the channel-shaped upper surface of the projection and the adjacent surface of the stabilized medium, as shown in FIG. 3. In use, water impinging on the stabilized medium 11 may not immediately be absorbed. In that case, water directed from the catchment area 30 may build up at the interface between the projection 20 and the stabilized medium 11. By providing an upper reservoir 31, this water can collect in the upper reservoir 31 to be more gradually absorbed by the stabilized medium 11, reducing the amount of water overflowing into the gaps between the cell wall 12 and the stabilized medium, on either side of the projection 20.

Each cell of the tray 100 is further configured such that a lower reservoir 36 is defined between each pair of adjacent projections 20, the stabilized-medium-supporting ribs 22 extending downwardly from those projections, the cell side walls 12 between the ribs, and the stabilized medium in the cell. As described above, the support edges of the ribs 22 are close to or in contact with the stabilized medium along a length of the stabilized medium 11.

One of the four lower reservoirs 36 is shown most clearly in FIGS. 2 and 4. The lower reservoir advantageously collects and contains, or retains, any water that flows into the gaps between the stabilized medium and the cell, including water that flows laterally off the sides of the upper surfaces of the projections, water which may flow over the cell-edge walls, and water which may fall directly into the lower reservoirs of the cell. Water flowing into the lower reservoir may impinge on, and so be absorbed by, the stabilized medium 11. Advantageously, this water may be absorbed by a lower portion of the stabilized medium than the upper portion supported by the projections 20. Any water flowing into the lower reservoir 36 may impinge on the stabilized medium along a substantial part of the length of the stabilized medium 11. This may advantageously reduce water wastage and ensure even watering of the stabilized medium along its length.

It should be noted that because of the clearances between the projections and the stabilized medium, and between the stabilizing ribs and the stabilized medium, any water entering the upper or lower reservoirs is not sealed into those reservoirs, but tends to leak out of the clearances. However, the rate of leakage is advantageously less than the rate of supply of water during watering, and so as water is supplied during watering, the water continuously flows from the catchment area into the upper and lower reservoirs, is continuously absorbed by the stabilized medium, and continuously leaks through the clearances at a lower rate. During watering, each reservoir thus retains a volume or head of water which is continuously absorbed by the stabilized medium. It may be noted that any leakage through the clearances also advantageously tends to flow down the side of the stabilized medium, giving a further opportunity for the stabilized medium to absorb the water. The only water that is wasted is any water that then flows away from the lower end of the stabilized medium without having been absorbed.

### Embodiment 2

FIG. 5 shows a portion of a plant-growing tray 200 according to a second embodiment of the invention. The tray comprises a tray top 214 and a plurality of cells 210, each cell extending downwardly in use from the tray top and being shaped to contain a substrate for a plant. The tray comprises a rectangular array of cells and is formed as a single piece from injection-moulded plastic. Not all of the cells of the tray are shown in FIG. 5.

In the embodiment shown in FIG. 5, the substrate is a suitable stabilized medium 11, for example an Ellepot®.

Each cell 210 comprises four symmetrically-arranged projections or lugs 220 that extend inwardly, into the cell, from an edge of the tray top surrounding the cell. Beneath each projection, the cell comprises a pair of stabilized-medium-supporting ribs 222 which extend downwardly from the projection to a cell base 216, within which a central hole is defined to allow access for a plunger for automated ejection of plants from the cells.

Each stabilized-medium-supporting rib comprises a support edge configured to support a stabilized medium positioned in the cell, along the length of the rib. Each support edge is flanged to increase the area of the rib which supports the stabilized medium, to reduce pressure on the stabilized medium. Between each pair of ribs, beneath each projection, an opening 223 allows ventilation to the stabilized medium, in use. The aperture is optional; in alternative embodiments of the invention when there is no aperture, the cell may comprise a continuous surface between each pair of ribs. Such an embodiment is shown in section in FIG. 10.

Adjacent projections, and the ribs extending downwardly from adjacent projections, are connected by cell side walls which extend from the tray top to the cell base. The side walls are formed in two portions. An upper portion 212 is curved laterally or radially outwardly so that, when a stabilized medium 11 is received in the cell, a lower reservoir 236 is formed (as shown in FIG. 8) between the stabilized medium and the upper portion of the side wall. This is advantageously of larger volume than the lower reservoir in the first embodiment.

A lower portion 213 of each side wall is shaped to match and support or contact the outer surface of a cylindrical stabilized medium placed in the cell. The contact, or small clearance, between this lower portion of the side wall and the stabilized medium defines a lower boundary or edge to the lower reservoir.

The depth of the lower reservoir may be designed to allow sufficient access for the mechanical fingers of automated machinery for handling the stabilized medium, to reach a sufficient portion of the length of the stabilized medium for secure handling.

FIGS. 5 and 6 show how each of the cells 210 of the plant-growing tray 200 is associated with a catchment area 230 of the tray top 214 having a sloped surface. In use, water is supplied to the tray to encourage the growth of strong and healthy plants growing in the stabilized medium. The water is preferably supplied from above using an overhead sprinkler system. A proportion of the water will impinge on catchment areas 230. The sloped surface of each catchment area 230 is configured such that, in use, the impinging water is directed towards the cell 210 associated with that catchment area 230. As each cell 210 is associated with a catchment area, water supplied to the tray is distributed evenly between each of the cells, rather than pouring into a subset of cells, even if the tray is not precisely level, or if there is a prevailing wind. This reduces the risk of some of the cells being flooded with water while others are not supplied with enough water.

Each catchment area 230 is associated with only one cell. Each catchment area 230 comprises four equal sections spaced around the cell, each associated with one of the four projections 220 of the cell.

Each section of the catchment area 230 is bounded by a perimeter ridge 225 and is shaped to slope down to an inclined valley 224, Each valley extends radially inwards from a perimeter of the catchment area to one of the projections. A cell-edge rib, or wall, 232 extends away from each projection around the edge of the tray top surrounding each cell. Therefore, water impinging on each of the catchment areas of the tray top is directed towards their associated cells, and specifically to each of the projections 220. The arrows of FIG. 6 indicate the direction of water flowing along the valleys towards a cell.

Each projection 220 has an upper surface 221 which slopes downwardly towards the stabilized medium from a first, upper, end adjacent to, and level with, with the catchment area 230 to a second, lower, end adjacent to an upper portion of the stabilized medium 11. The upper surface 221 of the projection is shaped to form a channel having an inlet at the upper end and an outlet at the lower end. FIG. 7 is a section of one of the cells, taken through two opposing projections 220. The catchment area and the upper surface of each projection forms a continuous surface. This allows water directed by the catchment area towards the projection to flow over the upper surface of the projection to the upper portion of stabilized medium. The water impinges upon the upper portion of the stabilized medium and can be absorbed.

The upper surface of each projection is also shaped to form an upper reservoir 231, as shown in FIG. 7. A first portion of the upper surface leading away from the tray top is convex, to accelerate a flow of water from the tray top towards the stabilized medium. A second portion of the upper surface is concave, to slow down the flow of water as it approaches the stabilized medium, and to provide a suitable shape for the upper reservoir, defined between the upper surface of the projection and the outer surface of the stabilized medium, to retain an amount of water. In use, water impinging on the stabilized medium 11 may not immediately be absorbed. In that case, a volume of the water directed by the catchment area 230 may build up in the upper reservoir to eventually be absorbed by the stabilized medium 11, reducing any overflow of water over either side of the projection 220.

It may be noted that the edges of the channel formed as the upper surface of each projection may be continuous with, or formed as extensions of, the cell-edge ribs, or walls, 232.

The cell comprises a lower reservoir 236 between each pair of adjacent projections, as described above. The lower reservoirs are shown most clearly in FIGS. 6 and 8. Each lower reservoir advantageously contains or retains any water that flows into the gaps between the stabilized medium and the cell, either flowing over edges of the projections or out of the upper reservoir, or directly over the cell-edge wall, or falling directly into the lower reservoir. This water held in the lower reservoir may then impinge on, and so be absorbed by, the stabilized medium 211 lower down than the upper portion of the stabilized medium supported by the projections 220. This may advantageously reduce water wastage.

Furthermore, the depth of the lower reservoir 236 with respect to the stabilized medium 11 may affect in which portion of the stabilized medium 11 water is predominantly absorbed. In the embodiment shown in FIG. 8, the lower reservoir 236 extends approximately three-quarters of the depth of the cell such the water will be absorbed in the stabilized medium 11 in a lower portion, or near its base. In other embodiments it may be preferred for water to be absorbed from the lower reservoir at a different position, higher or lower in the stabilized medium. A deeper lower reservoir may also advantageously allow the mechanical fingers of automated machinery for handling the stabilized medium to reach a greater portion of the length of the stabilized medium.

### Embodiment 3

FIG. 9 shows a third embodiment, in which a cell 310 of a plant-propagating tray has a differently-shaped side wall in which the lower portion 313 of the side wall that supports or contacts the stabilizing medium 11, and which delimits the lower edge of the lower reservoir 336, extends about half way up the stabilizing medium. Therefore, the lower reservoir 336 only extends about half way down the cell and water is absorbed into the stabilizing medium 11 from the lower reservoir 336 at a middle portion of, or about half way up, the stabilized medium.

### Embodiment 4

FIG. 10 shows a fourth embodiment of a single cell 410 of a plant-propagating tray. This embodiment is similar to that shown in FIGS. 5 to 8. However, in the fourth embodiment, there is no aperture defined below each projection. Instead, a cell wall 440 is formed between the stabilized-medium-supporting ribs beneath each projection 412, which supports the stabilized medium. This may be desirable for plants that do not require a high degree of ventilation or aeration, or where the stabilized medium requires additional support.

### Embodiment 5

FIGS. 11 and 12 illustrate a portion of a plant tray according to a fifth embodiment of the invention. FIG. 11 shows four adjacent cells of the tray. Features of the tray common to those of the first embodiment, illustrated in FIGS. 1 to 4, are identified with the same reference numerals.

Each cell 10 comprises four evenly-spaced projections 20 around its rim, for supporting an upper portion of a stabilized medium such as an Ellepot 11. The tray top comprises inclined catchment areas 30, which each comprise four catchment-area portions or sections surrounding each cell. Each catchment area comprises surfaces which slope towards valleys 24, which in turn slope downwardly towards upper surfaces 21 of the projections 20.

Between each adjacent pair of projections, a cell wall 12 is set back to form a gap between the cell wall and a stabilized medium supported in the cell. A cell-edge rib 32 extends along an upper edge of each cell wall, and alongside the upper surface 21 of each adjacent projection.

The tray further comprises a peripheral wall 250 surrounding each catchment area, and dividing each catchment area from adjacent catchment areas. The peripheral wall also extends around outer edges of the tray. The peripheral wall helps to ensure that during watering, water falling on one catchment area tends to be retained in that catchment area and does not splash or flow into adjacent catchment areas, even if the tray is not exactly level or if there is a prevailing wind.

### Embodiment 6

FIG. 13 illustrates a portion of a plant tray according to a sixth embodiment of the invention. FIG. 13 shows four adjacent cells of the tray. Features of the tray common to those of the first and fifth embodiments are identified with the same reference numerals.

Each cell 10 comprises four projections 20 around its rim, for supporting an upper portion of a stabilized medium such as an Ellepot 11. The tray top comprises inclined catchment areas 30, which each comprise four catchment-area portions or sections surrounding a cell. Each catchment area comprises surfaces which slope towards valleys 24 which in turn slope downwardly towards upper surfaces 21 of the projections 20. The upper surfaces of the projections are shaped to form upper reservoirs for retaining water in contact with an upper portion of the stabilized medium.

Between each adjacent pair of projections, a cell wall 12 is set back, to form a gap between the cell wall and a stabilized medium supported in the cell. In this embodiment, the cell wall is set back from the stabilized medium so that a central part of the cell wall lies along an outer edge of the catchment area.

As in the fifth embodiment, the tray comprises a peripheral wall 250 surrounding each catchment area, and dividing each catchment area from adjacent catchment areas. The peripheral wall in this embodiment is about the same height as in the fifth embodiment, at around 3 mm. In general, the peripheral wall height may be between about 1 mm and 10 mm, or between 2 mm and 5 mm or 7 mm.

The tray further comprises a ventilation hole 252 formed through the tray top at each corner of each catchment area. Thus, a ventilation hole is formed at each point at which four adjacent catchment areas meet. The peripheral wall of each catchment area extends along an edge of each adjacent ventilation hole, so that each ventilation hole is surrounded by peripheral walls. In this way, the peripheral walls prevent or reduce the rate at which water may splash or flow through the ventilation holes during watering. The ventilation holes advantageously provide additional ventilation to the space below the tray top and between the cells, preferably without significantly increasing water wastage. During watering, some water may pass through the ventilation holes and be wasted, but advantageously this may only be water which falls directly into the ventilation holes. Any water which falls on the catchment areas or into the cells well flow towards the Ellepot for absorption. Thus, the area of the ventilation holes may be limited to a predetermined area of the tray top, depending on the type of plants to be grown in the tray and the growing conditions.

### Embodiment 7

FIGS. 14 to 20 illustrate a plant-growing tray according to a seventh embodiment of the invention. Features of the tray common to those of earlier embodiments are identified with the same reference numerals.

FIGS. 14 and 15 are three-quarter views, from different angles, of a group of four adjacent cells which may be repeated to form a tray of any desired size. One cell is shown holding a stabilized medium 11 for growing a plant. The cells are arranged in a square array, and each cell 10 comprises four inwardly-facing projections 20 around its rim, one at each corner.

In use, the projections in each cell support an upper portion of a stabilized medium. Additional support for the stabilized medium is provided above the projections by a pair of cell-edge rims, or walls, 32 which extend upwardly at each side of each projection 20, and below the projections by a pair of stabilized-medium-supporting ribs 222 which extend downwardly from each side of each projection to a cell base. Between each pair of stabilized-medium-supporting ribs 222, below each projection 20, an aperture provides ventilation to the stabilized medium. At its base, the cell tapers inwards to encircle and support the base of the stabilized medium.

For each cell, the tray top comprises a catchment area in the form of four separate catchment-area portions or sections 30. Each catchment-area portion extends inwardly from a corner of the square tray-top section surrounding each cell, and slopes downwardly towards an upper surface 21 of a respective projection 20.

Each catchment-area portion is bounded on each side by the upstanding cell-edge ribs, or walls, 32 which extend from the tray top rim 25 to the projection 20. The cell-edge ribs and the upper surfaces of the projections define upper reservoirs for retaining water in contact with an upper portion of the stabilized medium. In this embodiment, the upper reservoirs are shaped to improve absorption of water by the stabilized medium. An upper part of each catchment-area portion is shaped similarly to the catchment area in FIG. 5, to transport water falling on the catchment area towards the stabilized medium as illustrated by the arrows in FIG. 16, and to form an upper portion of the upper reservoir. However, the downward slope of each catchment-area portion increases at its lower end, to form a substantially vertical, downwardly-extending surface ending at the projection 20. This can be seen in the sectional views of the cell of FIGS. 17 and 18. This vertical surface is bounded at its sides by the cell-edge ribs 32, which form support surfaces which abut, or are closely spaced from, the cylindrical surface of the stabilized medium.

The vertical, downwardly-extending surface of each catchment-area portion extends each upper reservoir downwards, forming a high-aspect-ratio lower portion 31′ of each upper reservoir 31. The lower portion can for example extend downwardly as much as 10% or 20% of the total height of the stabilized medium, it can extend around as much as 5% to 10% of the circumference of the stabilized medium, and the vertical surface of the catchment area is relatively closely spaced, in a radial direction, from the cylindrical surface of the stabilized medium, spaced only by the height of the cell-edge ribs flanking it on each side. The volume of each lower portion 31′ of the upper reservoir is therefore relatively small, although it contacts a relatively large area of the surface of the stabilized medium.

These dimensions and shape of the upper reservoir have the following beneficial effects.

When water falls on the catchment areas and flows towards the stabilized medium, the small volume of the lower portion 31′ of each upper reservoir is quickly filled. Further water then starts to fill the larger-volume upper portion of each upper reservoir. At the same time, because the area of the lower portion 31′ in contact with the stabilized medium is large, water is absorbed rapidly from the lower portion 31′ into the stabilized medium. As water is absorbed, the lower portion 31′ is continually refilled by water flowing from the upper portion of the upper reservoir, until the supply of watering water ceases.

As has been described earlier, because of the need for the stabilized medium to be removable from the cell, and because there is some variation in the dimensions of different stabilized media, a small clearance is needed between the stabilized medium 11 and the supporting projections 20 and the cell-edge ribs 32. During watering, water therefore leaks continuously from the upper reservoir at a rate dependent on the size of the clearance. By increasing the area of the upper reservoir in contact with the stabilized medium, and so increasing the rate of absorption of water by the stabilized medium, the lower portion 31′ of the upper reservoir reduces the time required for the stabilized medium to absorb a desired volume of water. This reduces watering time, and therefore the time during which water leaks from the upper reservoir through the clearance, reducing the amount of water potentially wasted.

The lower portion 31′ of each upper reservoir also increases the surface area of the stabilized medium through which water is absorbed, and so improves the distribution of water in the stabilized medium.

As shown in FIGS. 14 and 15, and in section in FIGS. 19 and 20, a cell wall 12 extends downwardly from the tray-top rim 25 between each adjacent pair of catchment-area portions 30. The cell wall 12 is spaced from the stabilized medium to form a lower reservoir 36, in the same way as in embodiments described above. During watering, water that falls directly into the lower reservoir, or which may overflow into the lower reservoir from the upper reservoirs or from the catchment area, collects in the lower reservoir for absorption by the stabilized medium.

In this embodiment, the cell wall 12 which bounds the lower reservoir is shaped so that the lower reservoir 36 comprises an upper portion and a lower portion 36′. As in other embodiments, the upper portion is wide enough and deep enough (extending about halfway down the length of the stabilized medium) to receive mechanical fingers and allow automated insertion and removal of the stabilized medium from the tray. In the lower portion 36′ the cell wall is closer to the stabilized medium, and extends further down the stabilized medium. Between the upper and lower portions the cell wall is formed with a step, where it moves closer to the stabilized medium. As shown in the sectional views of FIGS. 19 and 20, in this embodiment the lower portion 36′ of the lower reservoir extends substantially to the base of the stabilized medium, where the bottom end of the cell wall tapers inwards to contact and support the base of the stabilized medium and to close the bottom end of the lower portion 36′ of the lower reservoir.

The lower portion 36′ of the lower reservoir provides the same advantages as described above for the lower portion 31′ of the upper reservoir. The lower portion 36′ of the lower reservoir enables a small volume of water to contact a large area of the stabilized medium, for rapid water absorption into a lower part of the stabilized medium. The lower portion 36′ can be quickly refilled by water which has collected in the larger-volume upper portion of the lower reservoir. This reduces watering time, reduces water wastage, and increases the distribution of water to different parts of the stabilized medium.

In this embodiment, it should be noted that the supporting surfaces for the stabilized medium, namely the projections 20, the cell-edge ribs 32, and the stabilized-medium-supporting ribs 222, have advantageously optimized surfaces for contacting or supporting the stabilized medium. In particular, the cell-edge ribs and the stabilized-medium-supporting ribs are outwardly flanged at their edges which contact the stabilized medium. This decreases pressure at the points of contact between the cell and the stabilized medium, reducing the risk of damaging or distorting the stabilized medium and improving mechanization by reducing frictional forces between the stabilized medium and the cell during insertion and removal of the stabilized medium.

### Embodiment 8

FIG. 21 illustrates a four-cell portion of a plant-growing tray according to an eighth embodiment of the invention. The cells in this embodiment have similar features to those described above for the seventh embodiment, but the ratio of cell width to cell height is larger than in the seventh embodiment. This allows shorter, or wider, stabilized media to be accommodated while achieving the same advantages as in the seventh embodiment.

### Embodiment 9

FIGS. 22 to 26 illustrate a plant-growing tray according to a ninth embodiment of the invention. Features of the tray common to those of earlier embodiments are identified with the same reference numerals.

In this embodiment, cells are arranged in square array and bounded at the tray top by a peripheral wall 250 surrounding each cell. A tray-top catchment area 30 around each cell is bounded at its outer edge by the peripheral wall and at its inner edge by cell-edge rims 32, and slopes downwardly at each corner of the cell to an upper surface 21 of a stabilized-medium-supporting projection 20. This forms four upper reservoirs 31 spaced around a stabilized medium in the cell. Between each adjacent pair of upper reservoirs, a cell wall 12 extends downwardly from the cell-edge rim to define a lower reservoir 36 for providing water to a lower portion of the stabilized medium.

During watering, water falling on the catchment area flows into the upper reservoirs, and water falling directly into the lower reservoirs, or overflowing from the catchment area or from the upper reservoirs, flows into the lower reservoirs.

In certain applications, a stabilized medium in a cell may benefit from ventilation. In the cell of the present embodiment, ventilating apertures are formed below each projection 20, between pairs of stabilized-medium-supporting ribs 222 which extend downwardly from each side of each projection. However to increase ventilation, additional apertures 260 are provided in the cell walls 12. These apertures open into the lower reservoirs and so there is a risk that, during watering, water may flow out of the apertures and be wasted. To minimize this risk, aperture-surrounding walls 262 extend from edges of the apertures inwardly into the lower reservoirs. As shown in the sectional views in FIGS. 25 and 26, each wall is tapered in height, being highest at the upper end of the aperture. In addition, a tapered flange extends upwardly from the aperture-surrounding wall at an uppermost edge of the aperture. The flange and the wall divide and deflect water that flows or falls into the lower reservoir away from the aperture, reducing water wastage. The taper of the wall also provides a suitable draft angle to enable the cell to be moulded from plastic.

The flange also serves to guide the stabilized medium away from the aperture-surrounding wall as the stabilized medium is inserted into the cell, to avoid it snagging on the aperture-surrounding wall.

As can be seen in the section of FIG. 26, with a stabilized medium in the cell, the aperture-surrounding wall 262 does not contact the stabilized medium. Therefore, air can flow freely from the lower reservoir through the aperture, providing ventilation to the entire surface of the stabilized medium which faces the lower reservoir.

If during watering the water level in the lower reservoir rises to the level of the aperture, water will flow out of the aperture and be wasted. Therefore, the aperture is advantageously positioned sufficiently high on the side wall of the lower reservoir to allow the lower reservoir to contain enough water to provide a desired volume of water to the growing medium. However, it may still be desirable to control the rate of water supply during watering so that the rate of water absorption from the lower reservoir into the stabilized medium is sufficient to avoid water loss through the aperture.

### Embodiment 10

FIG. 27 illustrates a plant-growing tray according to a tenth embodiment of the invention. This embodiment has the same structure as that of the ninth embodiment, illustrated in FIGS. 22 to 26, except that each cell is deeper. The cells can therefore support longer stabilized media (or stabilized media of higher aspect ratio) than the cells of the ninth embodiment.

### Embodiment 11

Differently sized stabilized media are used for growing and propagating different plants.

The plant trays of the ninth and tenth embodiments have similar features and accommodate differently-sized stabilized media, but a grower would need to procure sets of such trays in order to grow many plants in differently-sized stabilized media. To solve this problem a more flexible system is provided by a further embodiment of the invention, namely the cell insert, or sled, illustrated in FIGS. 28 to 34. The cell insert is for use with plant-growing trays according to the ninth and tenth embodiments of the invention, and enables those trays to be used with longer stabilized media than the trays would normally be able to accommodate.

In the drawings, features of the cell insert, or sled, common to those of earlier embodiments are identified with the same reference numerals.

As shown in FIG. 28, the cell insert 500 is a single cell for receiving a stabilized medium, surrounded by a single-cell tray top 502 incorporating a catchment area for directing water to the stabilized medium. The cell insert can be inserted into a cell of the tray of the ninth embodiment, as shown in FIG. 29, or the tenth embodiment, as shown in FIG. 30. The external surface of the cell insert is shaped to slide securely into cells of either of these trays, and in each case to enable the tray to be used with longer stabilized media without the grower needing to purchase and store entire trays of the larger depth.

Cell inserts can be inserted into all of the cells of the trays of the ninth and tenth embodiments and, when this is done, the single-cell tray tops 502 of the inserts align with each other to form a full tray top having the same shape and features as that of the tray into which the cell inserts are inserted. The single-cell tray tops 502 are generally square in shape, having the same dimensions as the cells of the tray in which they are held, and they have rounded corners 504 so that when four cell inserts are placed in adjacent cells of a tray, a ventilation hole is formed between them.

The remaining features of the cell insert are the same as the cells of the trays of the ninth and tenth embodiments, forming upper and lower reservoirs for directing watering water to the stabilized medium. However because of the increased depth of the cell, the lower reservoirs are deeper than in the ninth and tenth embodiments and so two apertures 264, 268 are formed, one above the other, through the cell wall to increase ventilation in the lower reservoir. The apertures are surrounded by tapered walls 266, 268 in the same way as the apertures in the cell walls of the ninth and tenth embodiments. These can be seen in section in FIGS. 33 and 34.

In the same way as for the ninth embodiment described above, the lower apertures are positioned sufficiently high up the side walls of the lower reservoirs so that the reservoirs contain a desired volume of water to be absorbed by the growing medium, without water loss through the apertures.

### Embodiment 12

FIGS. 35 to 38 illustrate a four-cell portion of a plant-propagating tray according to a twelfth embodiment of the invention. The Figures illustrate four adjacent cells of the tray. Features of the tray common to those of earlier embodiments are identified with the same reference numerals.

Each cell 10 is encircled by a sloping catchment area 30. The catchment area slopes towards four valleys 24, which direct water towards a stabilized medium or Ellepot 11 supported in the cell.

The cell is a circular cell in which the cell wall tapers inwardly towards its base. The cell comprises four cell-wall portions 256 positioned between apertures 258 which extend downwardly from a point beneath an end of each valley 24. An edge 254 of the catchment area curves downwardly from the catchment area to the cell wall to form an upper reservoir, in use, encircling the Ellepot. The curvature of the edge 254 varies around the circumference of the Ellepot so that the upper reservoir is deepest at the ends of the valleys 24. In an alternative embodiment, the apertures 258 may be omitted, so that the cell is formed as a closed cell.

FIG. 36 illustrates with arrows the direction of water flow during watering. FIGS. 37 and 38 illustrate in section the formation of the upper reservoir encircling the Ellepot, and the curved cell edge 254 at the end of each valley 24. The outer periphery of the catchment area is square and FIGS. 37 and 38 are, respectively, sections taken diagonally and laterally across the catchment area and the cell. In both sections the slope angle of the catchment area, in a radial direction, is 30°, but because the distance between a corner of the periphery of the catchment area and the cell, shown in FIG. 16, is greater than the distance between an edge of the periphery of the catchment area and the cell, shown in FIG. 38, the catchment area creates a lower irrigation point, or a deeper upper reservoir, at the portions of the cell aligned with the corners of the periphery of the catchment area.

The plant tray in the twelfth embodiment may advantageously enable effective watering of a stabilized medium held in each cell, with significantly less water wastage than in prior-art trays, but the lack of spacing between the cell walls and the stabilized medium may disadvantageously prevent access for the mechanical fingers of a mechanized handling apparatus. Manual handling of plants in the tray may therefore be required.

1. A plant-growing tray comprising a tray top and a plurality of cells extending downwardly from the tray top, each cell for containing in use a substrate for a plant; wherein each cell is associated with a catchment area of the tray top having a sloped surface configured such that, in use, water impinging on the catchment area is directed towards the cell.

2. A plant-growing tray according to claim 1, wherein each cell is surrounded by its associated catchment area.

3. A plant-growing tray according to claim 1 or 2, wherein each catchment area is associated with only one cell.

4. A plant-growing tray according to any of claims 1 to 3, wherein the area of each catchment area is equal.

5. A plant-growing tray according to any of the preceding claims, further comprising a perimeter rib extending upwardly from the tray top along at least portion of, preferably all of, a perimeter of one or more of the catchment areas, preferably each catchment area.

6. A plant-growing tray according to any of the preceding claims, further comprising a plurality of ventilation holes defined through the tray top, at least one of the ventilation holes being located between adjacent catchment areas.

7. A plant-growing tray according to claim 6, wherein the ventilation hole located between adjacent catchment areas is bounded by a perimeter rib.

8. A plant-growing tray according to any of the preceding claims, wherein each cell comprises a plurality of projections spaced around and extending inwardly into the cell for, in use, supporting an upper portion of a stabilized medium; wherein an upper surface of each projection is preferably level with or lower than an adjacent portion of the catchment area.

9. A plant-growing tray according to claim 8, wherein the at least one of the projections is configured such that, in use, water directed by the catchment area flows over the upper surface.

10. A plant-growing tray according to claim 8 or 9, wherein at least one of the projections is configured such that, in use, water flowing over the upper surface of the projection impinges upon the stabilized medium.

11. A plant-growing tray according to any of claims 8 to 10, wherein the upper surface of at least one of the projections, and preferably of each projection, slopes downwardly into the cell towards the stabilized medium in use.

12. A plant-growing tray according to any of claims 8 to 11, wherein the upper surface at least one of the projections, and preferably of each projection, is shaped to form a channel.

13. A plant-growing tray according to any of claims 8 to 12, wherein the sloped upper surface of at least one of the projections, and preferably of each projection, is shaped to form an upper reservoir.

14. A plant-growing tray according to claim 13, in which the upper reservoir is shaped so that a portion of the upper reservoir has a high aspect ratio, being a ratio of the minimum lateral dimension of the reservoir portion to the maximum radial depth of the reservoir portion.

15. A plant-growing tray according to any of claims 8 to 14, wherein the tray comprises a plurality of upstanding ribs, the upstanding ribs extending around each cell between adjacent projections.

16. A plant-growing tray according to any of claims 8 to 15, wherein each catchment area is shaped such that in use water is directed to the upper surface of each of the plurality of projections.

17. A plant-growing tray according to claim 16, wherein the catchment area is shaped such that in use an equal amount of water is directed to each of the plurality of projections when water uniformly impinges on the catchment area.

18. A plant-growing tray according to any of claims 8 to 16, wherein each cell comprises a lower reservoir defined between adjacent projections wherein, in use, water flowing into the lower reservoir impinges on a lower portion of the stabilized medium.

19. A plant-growing tray according to claim 18, in which the lower reservoir is shaped so that a portion of the lower reservoir has a high aspect ratio, being a ratio of the minimum lateral dimension of the reservoir portion to the maximum radial depth of the reservoir portion.

20. A plant-growing tray according to any preceding claim, in which the tray is formed as a single piece.

21. A cell insert for a plant-growing tray, comprising a tray-top portion and a cell extending downwardly from the tray-top portion, the cell for containing in use a substrate for a plant, wherein the tray-top portion provides a catchment area for the cell, having a sloped surface configured such that, in use, water impinging on the catchment area is directed towards the cell.

22. A cell insert according to claim 21, receivable in a cell of a plant-growing tray according to any of claims 1 to 20.

23. A cell insert according to claim 22, in which when a cell insert is received in each cell of the plant-growing tray, the tray-top portions of the cell inserts abut to form a tray top in which each cell is associated with a catchment area of the tray top.

24. A cell insert according to claim 23, in which a plurality of cell inserts received in the cells of the plant-growing tray form a tray as defined in any of claims 1 to 19.

25. A method for watering plants in a plant-growing tray or a cell insert as defined in any preceding claim, in which water is provided from above the tray or cell insert, and water which falls onto the tray top or tray-top portion is directed from each catchment area into a cell associated with that catchment area.
